(19) United States
(12) Patent Application Publication
(10) Pub. No.: US 2024/0182822 A1
(43) Pub. Date: Jun. 6, 2024

(54) TREATMENT COMPOSITION WITH DELIVERY PARTICLES BASED ON MODIFIED CHITOSAN

(71) Applicant: The Procter & Gamble Company, Cincinnati, OH (US)

(72) Inventors: JOHAN SMETS, LUBBEEK (BE); CÉDRIC MARC TAHON, GENT (BE); MATTIA COLLU, SAINT-GILLES (BE); LINSHENG FENG, MENASHA, WI (US); ROBERT STANLEY BOBNOCK, MENASHA, WI (US); TRAVIS IAN BARDSLEY, APPLETON, WI (US)

(21) Appl. No.: 18/522,451

(22) Filed: Nov. 29, 2023

Related U.S. Application Data
(60) Provisional application No. 63/429,188, filed on Dec. 1, 2022.

(51) Int. Cl. C11D 3/50; B01J 13/18; C11D 3/37; C11D 11/00; C11D 17/00

(52) U.S. Cl. CPC C11D 3/505; B01J 13/18; C11D 3/3788; C11D 11/0017; C11D 17/0039

(57) ABSTRACT

A treatment composition that includes a treatment adjunct and a population of core/shell delivery particles, where the shell is made, at least in part, of a polymeric material that is the reaction product of a modified chitosan and at least one electrophile, wherein the modified chitosan is the reaction product of chitosan and a modifying compound, wherein the modifying compound is an epoxide, an aldehyde, or an α,β-unsaturated compound. Related methods of making and using such compositions.

### FIELD OF THE INVENTION

The present disclosure relates to a treatment composition that includes a treatment adjunct and a population of core/shell delivery particles, where the shell is made of a polymeric material that is the reaction product of a modified chitosan and at least one electrophile, wherein the modified chitosan is the reaction product of chitosan and a modifying compound, wherein the modifying compound is an epoxide, an aldehyde, or an α,β-unsaturated compound. The present disclosure also relates to related methods of making and using such compositions.

### BACKGROUND OF THE INVENTION

Delivery particles, particularly core/shell delivery particles, are a convenient way to delivery benefit agents in treatment compositions such as laundry products. For environmental reasons, it may be desirable to use delivery particles that have a wall made from naturally-derived and/or biodegradeable materials. Furthermore, it is preferred that such delivery particles show efficient encapsulation, good product compatibility, and good deposition and performance under target usage conditions.

Chitosan is a polysaccharide known to be used in the shells of delivery particles, but chitosan presents certain challenges. For example, chitosan is generally insoluble in water above pH 7, and tends to be cationic in aqueous mixtures below about pH 6.5. Furthermore, when dissolved, chitosan can form viscous solutions that are hard to handle or process. Additionally, due to its cationic charge, chitosan can interact with anionic materials and surfaces, which may result in aggregation or other physical instabilities, particularly in certain product matrices such as liquid laundry detergents.

Thus, there is a need for improved treatment compositions that include delivery particles derived, at least in part, from natural and/or biodegradable materials that show good product compatibility and/or performance.

### SUMMARY OF THE INVENTION

The present disclosure relates to treatment compositions that include chitosan-based core/shell delivery particles, where the chitosan used to make the shells is characterized by a particular molecular weight.

For example, the present disclosure relates to a treatment composition that includes a treatment adjunct and a population of delivery particles, where the delivery particles include a core and shell surrounding the core, where the core includes a benefit agent, where the shell includes a polymeric material that is the reaction product of a modified chitosan and an electrophile, where the modified chitosan includes the reaction product of chitosan and a modifying compound, where the modifying compound includes an epoxide, an aldehyde, or an α,β-unsaturated compound.

The present disclosure also relates to a method of making a treatment composition, where the method includes the steps of: providing a base composition, wherein the base composition comprises a treatment adjunct, and combining the population of delivery particles with the base composition, where the delivery particles are as described herein.

The present disclosure also relates to a method of treating a surface, where the method includes the step of: contacting a surface, preferably a fabric, with a treatment composition as described herein.

### BRIEF DESCRIPTION OF THE DRAWINGS

The figures herein are illustrative in nature and are not intended to be limiting.

FIG. 1 is a graph of zeta potential illustrating delivery particles prepared according to the invention.

### DETAILED DESCRIPTION OF THE INVENTION

The present disclosure relates to treatment compositions that include delivery particles having shells made, at least in part, from chitosan-based materials. In particular, the delivery particles include a shell comprising a reaction product of modified chitosan and an electrophile that can act as a cross-linking agent. The modified chitosan can alter the resulting surface charge of the delivery particles, which in turn can advantageously affect product compatibility and/or performance.

The modified chitosan may be made by reacting a chitosan polymer with a modifying compound that can form C—N covalent bonds with the amine groups of the chitosan, particularly primary or secondary amines. The modifying compound can be selected from an epoxide compound, an aldehyde compound or an α,β-unsaturated compound. The epoxide, aldehyde compound or α,β-unsaturated compound can be anionic, cationic, or nonionic. The modifying compound can contain acidic, hydroxyl, or quaternary ammonium groups.

Without wishing to be bound by theory, it is believed that modifying the chitosan results in a modified surface charge of the delivery particles, compared to particles made from an unmodified chitosan. Thus, the ultimate surface charge of the delivery particles can be modified and tailored by selection of the modifying compound and/or the timing of its addition, for example to the water phase or the emulsion. In particular, surface charge can be modified when the modifying compound is selected to have cationic or anionic groups.

Additionally or alternatively, modification of the chitosan can alter the solubility of the chitosan, which may facilitate improved particle formation and/or processibility, for example by reducing the viscosity.

The chitosan, delivery particles, treatment compositions, and related methods of the present disclosure are discussed in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein “consumer product,” means baby care, beauty care, fabric & home care, family care, feminine care, and/or health care products or devices intended to be used or consumed in the form in which it is sold, and not intended for subsequent commercial manufacture or modification. Such products include but are not limited to diapers, bibs, wipes; products for and/or methods relating to treating human hair, including bleaching, coloring, dyeing, conditioning, shampooing, styling; deodorants and antiperspirants; personal cleansing; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; adult incontinence products; products and/or methods relating to oral care including toothpastes, tooth gels, tooth rinses, denture adhesives, tooth whitening; over-the-counter health care including cough and cold remedies; pest control products; and water purification.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

For ease of reference in this specification and in the claims, the term “monomer” or “monomers” as used herein with regard to the structural materials that form the wall polymer of the delivery particles is to be understood as monomers, but also is inclusive of oligomers and/or prepolymers formed of the specific monomers.

As used herein, the term “water soluble material” means a material that has a solubility of at least 0.5% wt in water at 60° C.

As used herein, the term “oil soluble” means a material that has a solubility of at least 0.1% wt in the core of interest at 50° C.

As used herein, the term “oil dispersible” means a material that can be dispersed at least 0.1% wt in the core of interest at 50° C. without visible agglomerates.

As used herein, “delivery particles,” “particles,” “encapsulates,” “microcapsules,” and “capsules” are used interchangeably, unless indicated otherwise. As used herein, these terms typically refer to core/shell delivery particles.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Treatment Composition

The present disclosure relates to treatment compositions (or simply “compositions” as used herein). The compositions of the present disclosure may comprise a population of delivery particles and a treatment adjunct, each described in more detail below. The treatment compositions may be useful in the methods of treating surfaces, such as fabrics, described herein.

The treatment composition is preferably a consumer product composition. The consumer products compositions of the present disclosure may be useful in baby care, beauty care, fabric care, home care, family care, feminine care, and/or health care applications. The consumer product compositions may be useful for treating a surface, such as fabric, hair, or skin. The consumer product compositions may be intended to be used or consumed in the form in which it is sold. The consumer product compositions of the present disclosure are typically not intended for subsequent commercial manufacture or modification.

The consumer product composition may preferably be a fabric care composition, a hard surface cleaner composition, a dish care composition, a hair care composition (such as shampoo or conditioner), a body cleansing composition, or a mixture thereof, preferably a fabric care composition.

The consumer product composition may be a fabric care composition, such as a laundry detergent composition (including a heavy-duty liquid washing detergent or a unit dose article), a fabric conditioning composition (including a liquid fabric softening and/or enhancing composition), a laundry additive, a fabric pre-treat composition (including a spray, a pourable liquid, or a spray), a fabric refresher composition (including a spray), or a mixture thereof. The treatment composition is preferably a fabric conditioning composition, even more preferably a liquid fabric conditioning composition.

The composition may be a beauty care composition, such as a hair treatment product (including shampoo and/or conditioner), a skin care product (including a cream, lotion, or other topically applied product for consumer use), a shave care product (including a shaving lotion, foam, or pre- or post-shave treatment), personal cleansing product (including a liquid body wash, a liquid hand soap, and/or a bar soap), a deodorant and/or antiperspirant, or mixtures thereof.

The composition may be a home care composition, such as an air care, car care, dishwashing, hard surface cleaning and/or treatment, and other cleaning for consumer or institutional use.

The treatment composition may be in the form of a liquid composition, a granular composition, a hydrocolloid, a single-compartment pouch, a multi-compartment pouch, a dissolvable sheet, a pastille or bead, a fibrous article, a tablet, a stick, a bar, a flake, a foam/mousse, a non-woven sheet, or a mixture thereof.

The treatment composition may be in the form of a liquid. The liquid composition may preferably include from about 50% to about 97%, preferably from about 60% to about 96%, more preferably from about 70% to about 95%, or even from about 80% to about 95%, by weight of the fabric treatment composition, of water. The liquid composition may be a liquid fabric conditioner. The liquid may be packaged in a pourable bottle. The liquid may be packaged in an aerosol can or other spray bottle. Suitable containers are described in more detail below.

The treatment composition may be in the form of a solid. The composition may be in the form of a bead or pastille, which may be pastilled from a liquid melt. The composition may be an extruded product. The treatment composition may be in the form of a powder or granules.

The composition may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof. Pouched compositions may have relatively low amounts of water, for example less than about 20%, or less than about 15%, or less than about 12%, or less than about 10%, or less than about 8%, by weight of the detergent composition, of water.

The treatment composition may be in the form of a spray and may be dispensed, for example, from a bottle via a trigger sprayer and/or an aerosol container with a valve.

The treatment composition may have a viscosity of from 1 to 1500 centipoises (1-1500 mPa*s), from 100 to 1000 centipoises (100-1000 mPa*s), or from 200 to 500 centipoises (200-500 mPa*s) at 20 s⁻¹ and 21° C.

The treatment compositions of the present disclosure may be characterized by a pH of from about 2 to about 12, or from about 2 to about 8.5, or from about 2 to about 7, or from about 2 to about 5. The treatment compositions of the present disclosure may have a pH of from about 2 to about 4, preferably a pH of from about 2 to about 3.7, more preferably a pH from about 2 to about 3.5, preferably in the form of an aqueous liquid. It is believed that such pH levels facilitate stability of the quaternary ammonium ester compound, when present. On the other hand, detergent compositions are typically characterized by a pH of from about 7 to about 12, preferably from about 7.5 to about 11. The pH of a composition is determined by dissolving/dispersing the composition in deionized water to form a solution at 10% concentration, at about 20° C.

Additional components and/or features of the compositions are discussed in more detail below.

### Population of Delivery Particles

The treatment compositions of the present disclosure comprise a population of delivery particles. The delivery particles comprise a core and a shell surrounding the core. The core may comprise a benefit agent, and optionally a partitioning modifier. The core can be a liquid or a solid, preferably a liquid, at room temperature.

The treatment composition may comprise from about 0.05% to about 20%, or from about 0.05% to about 10%, or from about 0.1% to about 5%, or from about 0.2% to about 2%, by weight of the composition, of delivery particles. The composition may comprise a sufficient amount of delivery particles to provide from about 0.05% to about 10%, or from about 0.1% to about 5%, or from about 0.1% to about 2%, by weight of the composition, of the encapsulated benefit agent, which may preferably be perfume raw materials, to the composition. When discussing herein the amount or weight percentage of the delivery particles, it is meant the sum of the wall material and the core material.

The population of delivery particles according to the present disclosure may be characterized by a volume-weighted median particle size from about 1 to about 100 microns, preferably from about 10 to about 100 microns, preferably from about 15 to about 50 microns, more preferably from about 20 to about 40 microns, even more preferably from about 25 to about 35 microns. For certain compositions, it may be preferred that the population of delivery particles is characterized by a volume-weighted median particle size from about 1 to about 50 microns, preferably from about 5 to about 20 microns, more preferably from about 10 to about 15 microns. Different particle sizes are obtainable by controlling droplet size during emulsification.

The delivery particles may be characterized by a ratio of core to shell up to 99:1, or even 99.5:0.5, on the basis of weight. The shell may be present at a level of from about 1% to about 25%, preferably from about 1% to about 20%, preferably from about 1% to 15%, more preferably from about 5% to about 15%, even more preferably from about 10% to about 15%, even more preferably from about 10% to about 12%, by weight of the delivery particle. The shell may be present at a level of least 1%, preferably at least 3%, more preferably at least 5% by weight of the delivery particle. The shell may be present at a level of up to about 25%, preferably up to about 20%, more preferably up to about 15%, more preferably up to about 12%, by weight of the delivery particle.

Delivery particles prepared with chitosan typically exhibit positive zeta potentials. Such capsules have improved deposition efficiency on surfaces (such as certain fabrics, like cotton) and/or improved compatibilities in product formulations. At higher pH, the particles may be able to be made nonionic or anionic. The delivery particles may have surface charge by virtue of charged domains or charged pendant groups from the composition and process of the invention. Adjustment of surface charge of the shell may effectively be achieved when the modifying compound has cationic or anionic groups. The delivery particles may even be made to be nonionic or anionic through selection of the modifying compound and the pH.

The delivery particles may be cationic in nature, preferably cationic at a pH of 4.5. The delivery particles may be characterized by a zeta potential of at least 15 millivolts (mV) at a pH of 4.5. The delivery particles can be fashioned to have a zeta potential of at least 15 millivolts (mV) at a pH of 4.5, or even at least 40 mV at a pH of 4.5, or even at least 60 mV at a pH of 4.5.

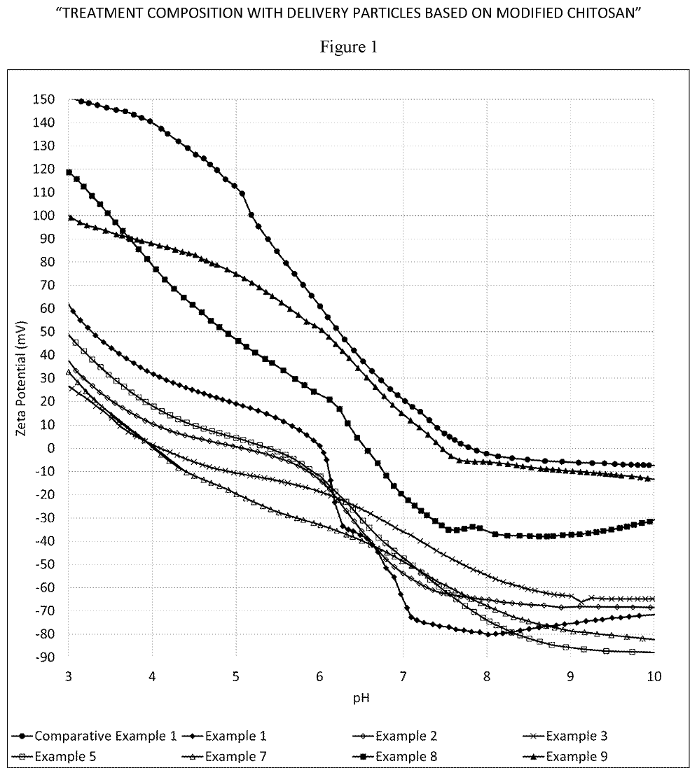

The delivery particles may be characterized by a zeta potential of 200 mV or less, preferably 150 mV or less, more preferably 100 mV or less, at pH 4.5. FIG. 1 shows the zeta potential of various delivery particles at various pHs, including particles according to the present disclosure.

The delivery particles of the present disclosure comprise a shell surrounding a core. (As used herein, “shell” and “wall” are used interchangeably with regard to the delivery particles, unless indicated otherwise.) The shell comprises a polymeric material. The polymeric material is the reaction product of chitosan, typically modified chitosan, and an electrophile.

The chitosan may comprise anionically modified chitosan, cationically modified chitosan, or a combination thereof. Modifying the chitosan in an anionic and/or cationic fashion can change the character of the shell of the delivery particle, for example, by changing the surface charge and/or zeta potential, which can affect the deposition efficiency and/or formulation compatibility of the particles.

The modified chitosan used in the shells of the delivery particles of the present disclosure can be prepared from chitosan, which may be acid-treated chitosan, that is modified with a modifying compound. The chitosan may be dissolved or dispersed in water. The modified chitosan is a nucleophile and is utilized as a cross-linker to form the shell of a core-shell microcapsule by cross-linking with an electrophile.

The modified chitosan may comprise the reaction product of chitosan and a modifying compound. Chitosan typically has free amine moieties (e.g., —NH2). A modified chitosan according to the present disclosure may result from chitosan combining with a modifying compound that can form C—N covalent bonds with the amine moieties of the chitosan. The modifying compound typically comprises an epoxide, an aldehyde, or an α,β-unsaturated compound.

The modifying compound may comprise a cationic group, an anionic group, a nonionic group, or a mixture thereof. The modifying compound may preferably comprise a cationic group, an anionic group, or a mixture thereof. The modifying compound may preferably comprise an anionic group, which can reduce the surface charge of the resulting particles.

The modifying compound may comprise an acidic group, a hydroxyl group, a quaternary ammonium group, or a mixture thereof, preferably an acidic group.

The modifying compound comprises an α,β-unsaturated compound, preferably wherein the α,β-unsaturated compound is an α,β-unsaturated carbonyl compound.

The modifying compound may be an α,β-unsaturated compound, preferably selected from the group consisting of an acrylate, an alkyl acrylate, an α,β-unsaturated ester, an acrylic acid, an acrylamide, a vinyl ketone, a vinyl sulfone, a vinyl phosphonate, an acrylonitrile, or a combination thereof. More preferably, the α,β-unsaturated compound is selected from group consisting of acrylic acid, acrylate salt, acrylate, alkyl acrylate, an α,β-unsaturated ester, maleic acid, vinyl sulfonic acid, 2-carboxyethyl acrylate, 2-(2-oxo-1-imidazolidinyl)ethyl methacrylate, 2-(2-oxo-1-imidazolidinyl)ethyl methacrylamide, (2-(acryloyloxy)ethyl)trimethylammonium salt, (3-(methacryloylamino)propyl) trimethylammonium salt, N,N-dialkylaminoalkyl acrylate, N,N-dialkylaminoalkyl acrylamide, (3-acrylamidopropyl)trimethylammonium salt, acrylamide, acrylamide salt, 3-sulfopropyl acrylate salt, 2-acrylamido-2-methyl-1-propanesulfonic acid and their salts, quaternized vinyl imidazole, diallyl dialkyl ammonium salts, vinyl amine, vinyl ketone, vinyl sulfone, vinyl phosphonate, acrylonitrile, and combinations thereof.

The modifying compound may comprise a material selected from the group consisting of glycidyl trimethylammonium salt, glycidyl isopropyl ether, glycidyl methacrylate, furfuryl glycidyl ether, glycidol, 1,4-butanediol diglycidyl ether, 2-ethylhexyl glycidyl ether, (3-glycidyloxypropyl) trimethoxysilane, poly(ethylene glycol) diglycidyl ether, trimethylolpropane triglycidyl ether, glutaraldehyde, alginate aldehyde, acrylic acid, acrylate salt, maleic acid, vinyl sulfonic acid, 2-carboxyethyl acrylate, 2-(2-oxo-1-imidazolidinyl)ethyl methacrylate, 2-(2-oxo-1-imidazolidinyl)ethyl methacrylamide, (2-(acryloyloxy)ethyl)trimethylammonium salt, (3-(methacryloylamino)propyl) trimethylammonium salt, N,N-dialkylaminoalkyl acrylate, N,N-dialkylaminoalkyl acrylamide, (3-Acrylamidopropyl)trimethylammonium salt, 3-sulfopropyl acrylate salt, 2-acrylamido-2-methyl-1-propanesulfonic acid and their salts, quaternized vinyl imidazole, diallyl dialkyl ammonium salts, vinyl amine, and combinations thereof.

Prior to modification, the chitosan typically comprises free amine (e.g., —NH2) moieties, which may react with the modifying compound. Thus, it may be useful to select appropriate amounts of modifying compound in order to efficiently run the reaction and/or to tune the resulting surface charge of the delivery particles. For example, it may be advantageous to select material in amounts such that the molar ratio of the modifying compound to the free amine moieties of the chitosan is from 0.1% to 100%, preferably from 10% to 100%, more preferably from 10% to 90%, even more preferably from 25% to 90%, even more preferably from 25% to 75%.

Modified chitosan according to the present disclosure may be soluble at pH above 6.0, even above 8.0, even further above 10.0. Increased solubility may facilitate improved particle formation and/or improved processing, for example by providing a solution having a reduced viscosity.

Advantageously, the surface charge of the crosslinked chitosan capsule can be modified before, during, or after the formation of the capsule shell. This may be accomplished by timing of the addition of the modifying compound. The addition can be to the water phase or to the emulsion. A water-soluble or dispersible modifying compound can be added to the water phase or the emulsion at room temperature or at elevated temperature. The modifying compound can be added during emulsification such as after milling or added thereafter at elevated temperature. The modifying compound, namely an epoxide, aldehyde or α,β-unsaturated compound, is reacted with free amine moieties of the chitosan.

The modified chitosan of the present disclosure makes possible forming a reacted polymer shell having a high proportion of modified chitosan moieties in the polymer. Such high weight percent proportions of modified chitosan in a modified chitosan delivery particle make possible an improved capsule system not previously achieved with interfacial type of encapsulation processes. The process and composition of the present disclosure differ from ionic type of processes based on coacervation, as the polymeric material of the present disclosure is covalently cross-linked.

The chitosan may be characterized by a weight average molecular weight of from about 100 kDa to about 600 kDa. Preferably, the chitosan is characterized by a weight average molecular weight (Mw) of from about 100 kDa to about 500 kDa, preferably from about 100 kDa to about 400 kDa, more preferably from about 100 kDa to about 300 kDa, even more preferably from about 100 kDa to about 200 kDa. The method used to determine the chitosan's molecular weight and related parameters is provided in the Test Methods section below and uses gel permeation chromatograph with multi-angle light scatter and refractive index detection (GPC-MALS/RI) techniques. Selecting chitosan having the preferred weight average molecular weight can result in capsules having suitable shell formation and/or desirable processibility.

The chitosan may be characterized by a degree of deacetylation of at least 50%, preferably from about 50% to about 99%, more preferably from about 75% to about 90%, even more preferably from about 80% to about 85%. The degree of deacetylation can affect the solubility of the chitosan, which in turn can affect its reactivity or behavior in the process of forming the particle shells. For example, a degree of deacetylation that is too low (e.g., below 50%) results in chitosan that is relatively insoluble and relatively unreactive. A degree of deacetylation that is relatively high can result in chitosan that is very soluble, resulting in relatively little of it traveling to the oil/water interface during shell formation.

The chitosan may preferably be acid-treated chitosan. For example, chitosan (which, prior to acid treatment, may be referred to as raw chitosan or parent chitosan) may preferably be treated at a pH of 6.5 or less with an acid for at least one hour, preferably from about one hour to about three hours, at a temperature of from about 25° C. to about 99° C., preferably from about 75° C. to about 95° C. The acid may be selected from a strong acid (such as hydrochloric acid), an organic acid (such as formic acid or acetic acid), or a mixture thereof. The chitosan may preferably be acid-treated at a pH of from 2 to 6.5, preferably from pH 3 to 6, or even from a pH of from 4 to 6.

As mentioned above, the shell is a polymeric material that is the reaction product of the chitosan and an electrophile. Preferably, the electrophile comprises a polyisocyanate. Thus, the shell of the delivery particles may comprise a polyurea resin, wherein the polyurea resin comprises the reaction product of a polyisocyanate and a chitosan.

The polyisocyanate material useful in the present disclosure is to be understood for purposes hereof as isocyanate monomer, isocyanate oligomer, isocyanate prepolymer, or dimer or trimer of an aliphatic or aromatic isocyanate. By “polyisocyanate,” it is intended to mean a material or compound that includes two or more isocyanate moieties. All such monomers, prepolymers, oligomers, or dimers or trimers of aliphatic or aromatic isocyanates are intended encompassed by the term “polyisocyanate” herein. The polyisocyanates useful in the present disclosure comprise isocyanate monomers, oligomers or prepolymers, or dimers or trimers thereof, having at least two isocyanate groups. Preferred cross-linking can be achieved with polyisocyanates having at least three functional groups.

Aromatic polyisocyanates may be preferred; however, aliphatic polyisocyanates and blends thereof may be useful. Aliphatic polyisocyanate is understood as a polyisocyanate which does not comprise any aromatic moiety. Aromatic polyisocyanate is understood as a polyisocyanate which comprises at least one aromatic moiety. The cross-linking agent may comprise a mixture of an aromatic polyisocyanate and an aliphatic polyisocyanate.

The polyisocyanate, when aromatic, can be, but is not limited to, methylene diphenyl isocyanate, toluene diisocyanate, tetramethylxylidene diisocyanate, polyisocyanurate of toluene diisocyanate (commercially available from Bayer under the tradename Desmodur® RC), trimethylol propane-adduct of toluene diisocyanate (commercially available from Bayer under the tradename Desmodur® L75), naphthalene-1,5-diisocyanate, phenylene diisocyanate, or trimethylol propane-adduct of xylylene diisocyanate (commercially available from Mitsui Chemicals under the tradename Takenate® D-110N).

Aliphatic polyisocyanates may include a trimer of hexamethylene diisocyanate, a trimer of isophorone diisocyanate, a trimethylol propane-adduct of hexamethylene diisocyanate (available from Mitsui Chemicals) or a biuret of hexamethylene diisocyanate (commercially available from Bayer under the tradename Desmodur® N 100).

Derivatives of polyisocyanates may include oligomers or polymers of isocyanate monomers. As a non-limiting example, the polyisocyanate may preferably comprise an oligomer or polymer of diphenylmethane diisocyanate (MDI), such as Mondur® MR-Light.

The polyisocyanate may preferably be selected from the group consisting of: a polyisocyanurate of toluene diisocyanate; a trimethylol propane adduct of toluene diisocyanate; a trimethylol propane adduct of xylylene diisocyanate; 2,2′-methylenediphenyl diisocyanate; 4,4′-methylenediphenyl diisocyanate; 2,4′-methylenediphenyl diisocyanate; [diisocyanato(phenyl)methyl]benzene; toluene diisocyanate; tetramethylxylidene diisocyanate; naphthalene-1,5-diisocyanate; 1,4-phenylene diisocyanate; 1,3-diisocyanatobenzene; derivatives thereof (such as pre-polymers, oligomers, and/or polymers thereof); and combinations thereof.

Electrophiles need not be limited to polyiscyanates. Electrophiles can comprise monomers, oligomers and prepolymers having electrophilic moieties and such electrophilic moieties can include any of formyl, keto, carboxyl, isocyanate, carboxylate ester, acyl halide, amides carboxylic anhydride, alkyl halide, epoxide, sulfonyl halide, chlorophosphate, β-unsaturated carbonyl, α,β-unsaturated nitrile, trifluoromethanesulfonate, p-toluenesulfonate, and α,β-unsaturated methanesulfonyl groups.

Suitable polyfunctional electrophiles can include glutaric dialdehyde, succinic dialdehyde, glyoxal; glyoxyl trimer, paraformaldehyde, bis(dimethyl) acetal, bis(diethyl) acetal, polymeric dialdehydes, such as oxidized starch, low molecular weight difunctional aldehydes, 1,3-propane dialdehyde, 1,4-butane dialdehyde, 1,5-pentane dialdehyde, or 1,6-hexane.

The particle shell may also be reinforced using additional co-crosslinkers such as multifunctional amines and/or polyamines, such as diethylene triamine (DETA), polyethylene imine, polyvinyl amine, or mixtures thereof. Acrylates may also be used as additional co-crosslinkers, for example to reinforce the shell.

The polymeric material may be formed in a reaction, where the weight ratio of the chitosan present in the reaction to the electrophile present in the reaction is from about 1:10 to about 1:0.1. It is believed that selecting desirable ratios of the biopolymer to the electrophile can provide desired ductility benefits, as well as improved biodegradability. It may be preferred that at least 21 wt % of the shell is comprised of moieties derived from chitosan, preferably from modified and/or acid-treated chitosan. Chitosan as a percentage by weight of the shell may be from about 21% up to about 95% of the shell. The ratio of chitosan in the water phase as compared to the electrophile, preferably a polyisocyanate, in the oil phase may be, based on weight, from 21:79 to 90:10, or even from 1:2 to 9:1, or even from 1:1 to 7:1. The shell may comprise chitosan at a level of 21 wt % or even greater, preferably from about 21 wt % to about 90 wt %, or even from 21 wt % to 85 wt %, or even 21 wt % to 75 wt %, or 21 wt % to 55 wt % of the total shell being chitosan. The chitosan of this paragraph is preferably modified according to the present disclosure and/or is acid-treated chitosan.

The population of delivery particles is made, or is obtainable by, a process comprising the following steps: forming a water phase by dissolving or dispersing chitosan in an aqueous acidic medium at a pH of 6.5 or less and a temperature of at least 25° C., the chitosan having free amine moieties; forming an oil phase comprising combining together at least one benefit agent and at least one electrophile, preferably at least one polyisocyanate, optionally with an added oil; forming an emulsion by mixing under high shear agitation the oil phase into an excess of the water phase, thereby forming droplets of the oil phase dispersed in the water phase; adding to the water phase and/or to the emulsion, preferably at least to the water phase, a modifying compound, the modifying compound comprising one or more of an epoxide, an aldehyde, or an α,β-unsaturated compound, the modifying compound reacting with the free amine moieties of the chitosan; optionally adjusting the pH of the emulsion to a pH of 4 or greater; and heating the emulsion to at least 40° C., for a time sufficient to form a shell at an interface of the droplets with the water phase, the shell surrounding the core.

The population of delivery particles is made, or is obtainable by, a process comprising the following steps: dissolving or dispersing chitosan into a water phase, the chitosan having amine moieties; combining the water phase and the modifying compound; optionally adjusting the pH of the water phase to pH 3.0 or higher, preferably from pH 3.0 to pH 6; optionally adjusting the temperature of the water phase to 25° C. or greater; mixing the water phase for a period of time, thereby forming a modified chitosan, wherein the modifying compound is covalently bonded through CN bonds with the amine moieties of the chitosan, wherein the modified chitosan remains dissolved in the water phase; providing an oil phase comprising dissolving together at least one benefit agent comprising an oil, and at least one electrophile, preferably at least one polyisocyanate, optionally with a second oil; forming an emulsion by mixing under high shear agitation the oil phase into the water phase, thereby forming droplets of the oil phase and benefit agent dispersed in the water phase; heating the emulsion to at least 40° C., for a time sufficient to form the shell at an interface of the droplets with the water phase, the shell surrounding the core.

After the chitosan is modified with the modifying compound, the pH of the water phase, comprising the modified chitosan solution, can be adjusted to above 6.5, or even above 7, or even above 9 if needed.

The molar ratio of the modifying compound to the free amine moieties of the chitosan may preferably be from 0.1% to 100%, preferably from 10% to 100%, more preferably from 25% to 90%.

The process of making the delivery particles may comprise forming a water phase by dissolving or dispersing chitosan and a modifying compound in an aqueous acidic medium at a pH of 6.5 or less and a temperature of at least 25° C.

The modifying compound, preferably a water-soluble or water-dispersible modifying compound, may be added to the water phase and/or the emulsion, preferably to the water phase, at room temperature or at elevated temperature. The modifying compound can be added during emulsification such as after milling or added thereafter at elevated temperature. As described in more detail above, the modifying compound contains cationic, anionic, or nonionic groups, typically selected from one or more acidic, or quaternary ammonium functional groups. The modifying compound, namely an epoxide, aldehyde or α,β-unsaturated compound, is reacted with free amine moieties of chitosan. The modifying compound is covalently bonded through C—N bonds with the primary or secondary amine moieties of the chitosan and helps to maintain the modified chitosan dissolved in the water phase even at high pH.

The pH of the emulsion may optionally be adjusted to a pH of 4 or greater, or even to a pH of 6, or even 8 or even to 8-10 or higher alkalinity. The emulsion may be heated to at least 40°C., for a time sufficient to form a shell at an interface of the droplets with the water phase, so that the shell surrounds the core. The delivery particles formed according to the process of the present disclosure, particularly when the modifying compound has cationic or anionic groups, results in the shell of the delivery particles having a surface charge. Such surface charged delivery particles may have a zeta potential of 200 mV or less, preferably 150 mV or less, at pH 4.5.

The emulsion may be cured by heating to at least 40° C., or even at least 60° C., for a time sufficient to form a shell at an interface of the droplets with the water phase. The shell is a polymeric material comprising the reaction product of the electrophile (e.g., polyisocyanate) and modified chitosan, the shell surrounding the droplets of the oil phase, which comprise the benefit agent. A target droplet size may be 0.1 to 100 microns, or even 0.5 to 50 microns.

To dissolve or disperse the chitosan, the chitosan may be processed by being acid-treated at a pH of less than 6.5, such as a pH of from pH 3 to pH 6, and a temperature of at least 25° C., or even at least 60° C., or even at least 80° C. The time of acid treatment, depending on pH and temperature, can be brief, but more typically would be at least one hour, or even for at least 24 hours. The chitosan may be deacetylated to at least 50% or even at least 75%, or even to at least 80%, or even to at least 85%, or even to at least 92%. Desirably, the chitosan has a weight average molecular weight of 600 kilodaltons (kDa) or less.

The chitosan may be modified by reacting it with a modifying compound comprising an epoxide, an aldehyde or an α,β-unsaturated compound. The shell formed may be considered a polyurea and the reaction product of polyisocyanate (e.g., comprising any of isocyanate monomer, oligomer or prepolymer) and the modified chitosan.

The population of delivery particles can be in the form of an aqueous slurry, or alternatively can be sprayed onto a substrate, or alternatively spray-dried, resulting in a polyurea-chitosan shell with further chitosan deposited on the surface of the formed delivery particles. The unreacted chitosan in the aqueous slurry, if not decanted, can form the further chitosan deposited on the surface of the formed microcapsules.

A redox initiator, preferably comprising a persulfate or a peroxide, may be added to the water phase and/or to the emulsion. A redox initiator, which may comprise a persulfate or a peroxide, can be added to the acid-treated chitosan. In an in situ variation, a redox initiator can be added to the emulsion following combining of the oil phase and water phase under high shear agitation. The redox initiator advantageously depolymerizes the hydrolyzed chitosan or modified chitosan reducing viscosity facilitating polymer formation of the shell in the capsule formation process. Modification of chitosan with the epoxide, aldehyde, or α,β-unsaturated compound is preferably accomplished prior to addition of the redox initiator, although the redox initiator (peroxide or persulfate) can be introduced at the same time as the modifying compound or even before. The redox initiator can be selected from the group consisting of ammonium persulfate, sodium persulfate, potassium persulfate cesium persulfate, benzoyl peroxide, hydrogen peroxide, and mixtures thereof. The redox initiator, preferably a persulfate or peroxide, may be present at a level of from about 0.1 wt % to about 99 wt % of the chitosan.

For clarity, there may several variations to the process. The acidified chitosan solution can be treated with the modifying compound by addition of the modifying compound to the chitosan in the water phase. Additionally or alternatively, the modifying compound can be added to the emulsion. Similarly and independently, an optional redox initiator can be added to the chitosan in solution which is acidified (e.g., the water phase), or added into the emulsion in the emulsification step following addition of the oil phase. The redox initiator can be added before, concurrently, or sequentially after the modification step with the modifying compound comprising epoxide, aldehyde, or an α,β-unsaturated compound.

The shell may degrade at least 50% after 20 days (or less) when tested according to test method OECD 301B. The shell may degrade at least 60% of its mass after 60 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

The delivery particles of the present disclosure include a core. The core comprises a benefit agent. The core optionally comprises a partitioning modifier.

The core of a particle is surrounded by the shell. When the shell is ruptured, the benefit agent in the core is released. Additionally or alternatively, the benefit agent in the core may diffuse out of the particle, and/or it may be squeezed out. Suitable benefit agents located in the core may include benefit agents that provide benefits to a surface, such as a fabric or hair.

The core may comprise from about 5% to about 100%, by weight of the core, of a benefit agent, which may preferably comprise a fragrance. The core may comprise from about 45% to about 95%, preferably from about 50% to about 80%, more preferably from about 50% to about 70%, by weight of the core, of the benefit agent, which may preferably comprise a fragrance.

The benefit agent may comprise an aldehyde-comprising benefit agent, a ketone-comprising benefit agent, or a combination thereof. Such benefit agents, such as aldehyde- or ketone-containing perfume raw materials, are known to provide preferred benefits, such as freshness benefits. The benefit agent may comprise at least about 20%, preferably at least about 25%, more preferably at least about 40%, even more preferably at least about 50%, by weight of the benefit agent, of aldehyde-containing benefit agents, ketone-containing benefit agents, or combinations thereof.

The benefit agent may be a hydrophobic benefit agent. Such agents are compatible with the oil phases that are common in making the delivery particles of the present disclosure.

The benefit agent is selected so as to provide a benefit under preferred uses of the treatment composition. The benefit agent in the core may be selected from the group consisting of fragrance materials, silicone oils, waxes, hydrocarbons, higher fatty acids, essential oils, lubricants, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, fabric comfort agents, shrinkage resistance agents, stretch resistance agents, stretch recovery agents, skin care agents, synthetic or natural actives, antibacterial actives, antiperspirant actives, cationic polymers, dyes, and mixtures thereof.

The benefit agent in the core preferably comprises fragrance material (or simply “fragrance”), which may include one or more perfume raw materials. Fragrance is particularly suitable for encapsulation in the presently described delivery particles, as the fragrance-containing particles can provide freshness benefits across multiple touchpoints.

The term “perfume raw material” (or “PRM”) as used herein refers to compounds having a molecular weight of at least about 100 g/mol and which are useful in imparting an odor, fragrance, essence or scent, either alone or with other perfume raw materials. Typical PRMs comprise inter alia alcohols, ketones, aldehydes, esters, ethers, nitrites and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs may be characterized by their boiling points (B.P.) measured at the normal pressure (760 mm Hg), and their octanol/water partitioning coefficient (P), which may be described in terms of log P, determined according to the test method below. Based on these characteristics, the PRMs may be categorized as Quadrant I, Quadrant II, Quadrant III, or Quadrant IV perfumes, as described in more detail in U.S. Pat. No. 6,869,923. Suitable Quadrant I, II, III, and IV perfume raw materials are disclosed therein.

Perfume raw materials having a boiling point B.P. lower than about 250° C. and a log P lower than about 3 are known as Quadrant I perfume raw materials. Quadrant I perfume raw materials are preferably limited to less than 30% of the fragrance material.

The fragrance may comprise perfume raw materials that have a log P of from about 2.5 to about 4. It is understood that other perfume raw materials may also be present in the fragrance.

The core of the delivery particles of the present disclosure may comprise a partitioning modifier, which may facilitate more robust shell formation. The partitioning modifier may be combined with the core's perfume oil material prior to incorporation of the wall-forming monomers. The partitioning modifier may be present in the core at a level of from 0% to 95%, preferably from about 5% to about 55%, preferably from about 10% to about 50%, more preferably from about 20% to about 50%, even more preferably from about 25% to about 50%, by weight of the core.

The partitioning modifier may comprise a material selected from the group consisting of vegetable oil, modified vegetable oil, mono-, di-, and tri-esters of C₄-C₂₄ fatty acids, isopropyl myristate, dodecanophenone, lauryl laurate, methyl behenate, methyl laurate, methyl palmitate, methyl stearate, and mixtures thereof. The partitioning modifier may preferably comprise or even consist of isopropyl myristate. The modified vegetable oil may be esterified and/or brominated. The modified vegetable oil may preferably comprise castor oil and/or soy bean oil. US Patent Application Publication 20110268802, incorporated herein by reference, describes other partitioning modifiers that may be useful in the presently described delivery particles.

Where the benefit agent is not itself sufficient to serve as the oil phase or solvent, particularly during the process of forming the shell of the delivery particles for the wall forming materials, the oil phase can comprise a suitable carrier and/or solvent. In this sense, the oil is optional, as the benefit agent itself can at times be the oil. These carriers or solvents are generally an oil, preferably have a boiling point greater than about 80° C. and low volatility and are non-flammable. Though not limited thereto, they preferably comprise one or more esters, preferably with chain lengths of up to 18 carbon atoms or even up to 42 carbon atoms and/or triglycerides such as the esters of C6 to C12 fatty acids and glycerol.

Optionally, the water phase may include an emulsifier. Non-limiting examples of emulsifiers include anionic surfactants (such as alkyl sulfates, alkyl ether sulfates, and/or alkyl benzenesulfonates), nonionic surfactants (such as alkoxylated alcohols, preferably comprising ethoxy groups), polyvinyl alcohol, and/or polyvinyl pyrrolidone. It may be that solubilized chitosan can provide emulsifying benefits in the present applications. Emulsifier, if employed, is typically from about 0.1 to 40% by weight, preferably 0.2 to about 15% by weight, more typically 0.5 to 10% be weight, based on total weight of the aqueous phase.

The population of delivery particles may be provided as a slurry, preferably an aqueous slurry. The slurry can include one or more processing aids, which may include water, aggregate inhibiting materials such as divalent salts, or particle suspending polymers such as xanthan gum, guar gum, cellulose (preferably microfibrillated cellulose) and/or carboxy methyl cellulose. When the delivery particles are characterized by a cationic nature (for example, when the shell is derived, at least in part, from chitosan), a non-anionic structurant, preferably a nonionic structurant, may be preferred, for example, to avoid detrimental charge interactions that may lead to undesirable aggregation.

The slurry can include one or more carriers selected from the group consisting of polar solvents, including but not limited to, water, ethylene glycol, propylene glycol, polyethylene glycol, glycerol; nonpolar solvents, including but not limited to, mineral oil, perfume raw materials, silicone oils, hydrocarbon paraffin oils; and mixtures thereof. Aqueous slurries may be preferred. The slurry may comprise non-encapsulated (of “free”) perfume raw materials that are different in identity and/or amount from those that are encapsulated in the cores of the delivery particles.

The slurry may include a deposition aid that may comprise a polymer selected from the group comprising: polysaccharides, such as chitosan, cationically modified starch and/or cationically modified guar; polysiloxanes; poly diallyl dimethyl ammonium halides; copolymers of poly diallyl dimethyl ammonium chloride and polyvinyl pyrrolidone; a composition comprising polyethylene glycol and polyvinyl pyrrolidone; acrylamides; imidazoles; imidazolinium halides; polyvinyl amine; copolymers of poly vinyl amine and N-vinyl formamide; polyvinyl formamide, polyvinyl alcohol; polyvinyl alcohol crosslinked with boric acid; polyacrylic acid; polyglycerol ether silicone cross-polymers; polyacrylic acids, polyacrylates, copolymers of polyvinylamine and polvyinylalcohol oligomers of amines, in one aspect a diethylenetriamine, ethylene diamine, bis(3-aminopropyl)piperazine, N,N-Bis-(3-aminopropyl)methylamine, tris(2-aminoethyl)amine and mixtures thereof; polyethyleneimine, a derivatized polyethyleneimine, in one aspect an ethoxylated polyethyleneimine; a polymeric compound comprising, at least two moieties selected from the moieties consisting of a carboxylic acid moiety, an amine moiety, a hydroxyl moiety, and a nitrile moiety on backbone a of polybutadiene, polyisoprene, polybutadiene/styrene, polybutadiene/acrylonitrile, carboxyl-terminated polybutadiene/acrylonitrile or combinations thereof; pre-formed coacervates of anionic surfactants combined with cationic polymers; polyamines and mixtures thereof.

At least one population of delivery particles may be contained in an agglomerate and then combined with a distinct population of delivery particles and at least one adjunct material. Said agglomerate may comprise materials selected from the group consisting of silicas, citric acid, sodium carbonate, sodium sulfate, sodium chloride, and binders such as sodium silicates, modified celluloses, polyethylene glycols, polyacrylates, polyacrylic acids, zeolites and mixtures thereof.

Suitable equipment for use in the processes disclosed herein may include continuous stirred tank reactors, homogenizers, turbine agitators, recirculating pumps, paddle mixers, plough shear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Socborg, Denmark), Hosokawa Bepex Corp. (Minneapolis, Minn., U.S.A.), Arde Barinco (New Jersey, U.S.A.).

### Adjunct Ingredient

The treatment compositions of the present disclosure may comprise one or more adjunct materials in addition to the delivery particles. The adjunct material may provide a benefit in the intended end-use of a composition, or it may be a processing and/or stability aid.

Suitable adjunct materials may include: surfactants, conditioning actives, deposition aids, rheology modifiers or structurants, bleach systems, stabilizers, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure elasticizing agents, carriers, hydrotropes, processing aids, anti-agglomeration agents, coatings, formaldehyde scavengers, and/or pigments. Preferably, the adjunct materials comprise additional fabric conditioning agents, dyes, pH control agents, solvents, rheology modifiers, structurants, cationic polymers, surfactants, perfume, additional perfume delivery systems, chelants, antioxidants, preservatives, or mixtures thereof.

Depending on the intended form, formulation, and/or end-use, compositions of the present disclosure might not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids, structurants, anti-agglomeration agents, coatings, formaldehyde scavengers, and/or pigments.

The precise nature of these additional components, and levels of incorporation thereof, will depend on the physical form of the composition and the nature of the operation for which it is to be used. However, when one or more adjuncts are present, such one or more adjuncts may be present as detailed below. The following is a non-limiting list of suitable additional adjuncts.

### A. Surfactants

The compositions of the present disclosure may comprise surfactant. Surfactants may be useful for providing, for example, cleaning benefits. The compositions may comprise a surfactant system, which may contain one or more surfactants.

The compositions of the present disclosure may include from about 0.1% to about 70%, or from about 2% to about 60%, or from about 5% to about 50%, by weight of the composition, of a surfactant system. Liquid compositions may include from about 5% to about 40%, by weight of the composition, of a surfactant system. Compact formulations, including compact liquids, gels, and/or compositions suitable for a unit dose form, may include from about 25% to about 70%, or from about 30% to about 50%, by weight of the composition, of a surfactant system.

The surfactant system may include anionic surfactant, nonionic surfactant, zwitterionic surfactant, cationic surfactant, amphoteric surfactant, or combinations thereof. The surfactant system may include linear alkyl benzene sulfonate, alkyl ethoxylated sulfate, alkyl sulfate, nonionic surfactant such as ethoxylated alcohol, amine oxide, or mixtures thereof. The surfactants may be, at least in part, derived from natural sources, such as natural feedstock alcohols.

Suitable anionic surfactants may include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. The anionic surfactants may be linear, branched, or combinations thereof. Preferred surfactants include linear alkyl benzene sulfonate (LAS), alkyl ethoxylated sulfate (AES), alkyl sulfates (AS), or mixtures thereof. Other suitable anionic surfactants include branched modified alkyl benzene sulfonates (MLAS), methyl ester sulfonates (MES), sodium lauryl sulfate (SLS), sodium lauryl ether sulfate (SLES), and/or alkyl ethoxylated carboxylates (AEC). The anionic surfactants may be present in acid form, salt form, or mixtures thereof. The anionic surfactants may be neutralized, in part or in whole, for example, by an alkali metal (e.g., sodium) or an amine (e.g., monoethanolamine). Due to the presence of cationic ester quat material, it may be desirable to limit the amount of anionic surfactant so as to avoid undesirable interactions of the materials; for example, the compositions may comprise less than 5%, preferably less than 3%, more preferably less than 1%, even more preferably less than 0.1%, by weight of the composition, of anionic surfactant.

The surfactant system may include nonionic surfactant. Suitable nonionic surfactants include alkoxylated fatty alcohols, such as ethoxylated fatty alcohols. Other suitable nonionic surfactants include alkoxylated alkyl phenols, alkyl phenol condensates, mid-chain branched alcohols, mid-chain branched alkyl alkoxylates, alkylpolysaccharides (e.g., alkylpolyglycosides), polyhydroxy fatty acid amides, ether capped poly(oxyalkylated) alcohol surfactants, and mixtures thereof. The alkoxylate units may be ethyleneoxy units, propyleneoxy units, or mixtures thereof.

The nonionic surfactants may be linear, branched (e.g., mid-chain branched), or a combination thereof. Specific nonionic surfactants may include alcohols having an average of from about 12 to about 16 carbons, and an average of from about 3 to about 9 ethoxy groups, such as C12-C14 EO7 nonionic surfactant.

Suitable zwitterionic surfactants may include any conventional zwitterionic surfactant, such as betaines, including alkyl dimethyl betaine and cocodimethyl amidopropyl betaine, C₈ to C₁₈ (for example from C₁₂ to C₁₈) amine oxides (e.g., C₁₂₋₁₄ dimethyl amine oxide), and/or sulfo and hydroxy betaines, such as N-alkyl-N,N-dimethylammino-1-propane sulfonate where the alkyl group can be C₈ to C₁₈, or from C₁₀ to C₁₄. The zwitterionic surfactant may include amine oxide.

Depending on the formulation and/or the intended end-use, the composition may be substantially free of certain surfactants. For example, liquid fabric enhancer compositions, such as fabric softeners, may be substantially free of anionic surfactant, as such surfactants may negatively interact with cationic ingredients.

### B. Conditioning Active

The compositions of the present disclosure may include a conditioning active. Compositions that contain conditioning actives may provide softness, anti-wrinkle, anti-static, conditioning, anti-stretch, color, and/or appearance benefits.

Conditioning actives may be present at a level of from about 1% to about 99%, by weight of the composition. The composition may include from about 1%, or from about 2%, or from about 3%, to about 99%, or to about 75%, or to about 50%, or to about 40%, or to about 35%, or to about 30%, or to about 25%, or to about 20%, or to about 15%, or to about 10%, by weight of the composition, of conditioning active. The composition may include from about 5% to about 30%, by weight of the composition, of conditioning active.

Conditioning actives suitable for compositions of the present disclosure may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof. Preferably the treatment composition is a fabric care composition where the one or more adjunct ingredients comprises quaternary ammonium ester material; such materials are particularly useful in fabric enhancing/conditioning/softening compositions.

The composition may include a quaternary ammonium ester compound, a silicone, or combinations thereof, preferably a combination. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1.

The composition may contain mixtures of different types of conditioning actives. The compositions of the present disclosure may contain a certain conditioning active but be substantially free of others. For example, the composition may be free of quaternary ammonium ester compounds, silicones, or both. The composition may comprise quaternary ammonium ester compounds but be substantially free of silicone. The composition may comprise silicone but be substantially free of quaternary ammonium ester compounds.

### C. Deposition Aid

The compositions of the present disclosure may comprise a deposition aid. As described above, due to the synergistic benefits that flow from the ester quat material and the delivery particles of the present disclosure, relatively less (or even none) of a deposition aid may be require to provide comparable or even improved performance; alternatively, a deposition aid may be used in compositions of the present disclosure to boost performance even more.

Deposition aids can facilitate deposition of delivery particles, conditioning actives, perfumes, or combinations thereof, improving the performance benefits of the compositions and/or allowing for more efficient formulation of such benefit agents. The composition may comprise, by weight of the composition, from 0.0001% to 3%, preferably from 0.0005% to 2%, more preferably from 0.001% to 1%, or from about 0.01% to about 0.5%, or from about 0.05% to about 0.3%, of a deposition aid. The deposition aid may be a cationic or amphoteric polymer, preferably a cationic polymer.

Cationic polymers in general and their methods of manufacture are known in the literature. Suitable cationic polymers may include quaternary ammonium polymers known the “Polyquaternium” polymers, as designated by the International Nomenclature for Cosmetic Ingredients, such as Polyquaternium-6 (poly(diallyldimethylammonium chloride), Polyquaternium-7 (copolymer of acrylamide and diallyldimethylammonium chloride), Polyquaternium-10 (quaternized hydroxyethyl cellulose), Polyquaternium-22 (copolymer of acrylic acid and diallyldimethylammonium chloride), and the like.

The deposition aid may be selected from the group consisting of polyvinylformamide, partially hydroxylated polyvinylformamide, polyvinylamine, polyethylene imine, ethoxylated polyethylene imine, polyvinylalcohol, polyacrylates, and combinations thereof. The cationic polymer may comprise a cationic acrylate.

Deposition aids can be added concomitantly with delivery particles (at the same time with, e.g., encapsulated benefit agents) or directly/independently in the consumer product composition. The weight-average molecular weight of the polymer may be from 500 to 5000000 or from 1000 to 2000000 or from 2500 to 1500000 Dalton, as determined by size exclusion chromatography relative to polyethyleneoxide standards using Refractive Index (RI) detection. The weight-average molecular weight of the cationic polymer may be from 5000 to 37500 Dalton.

### D. Rheology Modifier/Structurant

The compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles in liquid composition, such as the delivery particles as described herein.

Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof.

Polymeric structuring agents may be naturally derived or synthetic in origin. Naturally derived polymeric structurants may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof. Synthetic polymeric structurants may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C₁-C₃₀ alkyl ester of the (meth)acrylic acid. Such copolymers are available from Noveon inc under the tradename Carbopol Aqua 30. Cross-linked polymers, such as cross-linked polyacrylate and/or polymers and/or co-polymers, such as those that further include nonionic monomers such as acrylamide or methacrylamide monomers, may be useful as structurants. Another suitable structurant is sold under the tradename Rheovis CDE, available from BASF.

### E. Other Adjuncts

The treatment compositions of the present disclosure may contain other adjuncts that are suitable for inclusion in the product and/or for final usage. For example, the treatment compositions may comprise neat perfume, perfume delivery technologies (such as pro-perfumes and/or encapsulates having non-polyisocyanate/chitosan wall materials), cationic surfactants, cationic polymers, solvents, suds supressors, or combinations thereof.

### Method of Making a Treatment Composition

The present disclosure further relates to methods for making a treatment composition, such as those treatment compositions and/or consumer product compositions described herein.

The method may comprise the steps of: providing a base composition, wherein the base composition comprises the treatment adjunct, and combining the population of delivery particles with the base composition. The population of delivery particles may preferably be provided as an aqueous slurry. The base composition is in the form of a liquid composition.

The delivery particles may be combined with the one or more adjunct ingredients when the delivery particles are in one or more forms, including a slurry form, neat particle form, and/or spray dried particle form, preferably slurry form. The delivery particles may be combined with such adjuncts by methods that include mixing and/or spraying.

The treatment compositions of the present disclosure can be formulated into any suitable form and prepared by any process chosen by the formulator. The one or more adjunct ingredients and the delivery particles may be combined in a batch process, in a circulation loop process, and/or by an in-line mixing process. Suitable equipment for use in the processes disclosed herein may include continuous stirred tank reactors, homogenizers, turbine agitators, recirculating pumps, paddle mixers, high shear mixers, static mixers, plough shear mixers, ribbon blenders, vertical axis granulators and drum mixers, both in batch and, where available, in continuous process configurations, spray dryers, and extruders.

The treatment composition may be placed into a container to form a consumer product, as described herein. The container may be a bottle, preferably a plastic bottle. The treatment composition may be placed into an aerosol or other spray container according to known methods.

### Method of Treatment

The present disclosure also relates to a method of treating a surface, preferably a fabric. In general, the method includes the step of contacting a surface, preferably a fabric, with a treatment composition according to the present disclosure, where the treatment composition includes a population of delivery particles as described herein.

Additionally or alternatively, the method may include the step of contacting a surface, preferably a fabric, with a population of delivery particles as described herein. The population of delivery particles may be contained in a treatment composition according to the present disclosure, preferably a fabric care composition.

The method may include the step of contacting a fabric, such as a garment, with a treatment composition. The treatment composition comprises a population of delivery particles. The contacting step results in one or more of the delivery particles being deposited on a surface of the fabric. The delivery particles comprise a core and a shell surrounding the core, where the core comprises a benefit agent, preferably a fragrance material that comprises one or more perfume raw materials. The shell comprises a polymeric material that is, for example, the reaction product of chitosan of a particular molecular weight and a cross-linking agent. Suitable treatment compositions and delivery particles are described in more detail above.

The contacting step may occur during a manual laundry process, for example in a wash basin as fabrics are treated by hand, or an automatic laundry process, for example in an automatic washing machine. The contacting step may occur during the wash cycle of an automatic washing machine; in such cases, the treatment composition may be a laundry detergent or a laundry additive. The contacting step may preferably occur during the rinse cycle of an automatic washing machine; in such cases, the treatment composition may be a fabric enhancer, preferably a liquid fabric enhancer. The contacting step may even occur during a drying step of a laundry process, for example in an automatic dryer machine; in such cases, the treatment composition may be in the form of a non-woven dryer sheet or a dryer bar. The contacting step may occur as a result of the treatment composition being directly applied to the fabric, for example in a pretreatment operation or in a “refreshing” step (e.g., for a fabric that has been used or worn since the last wash); in such cases, the treatment composition may be in the form of a liquid, a stick, or a spray, preferably a spray. Contacting the target fabrics relatively late in a laundering process, e.g., during a rinse cycle, improves the likelihood or efficiency of deposition onto the fabrics as they are less likely to be washed down the drain.

The contacting step may occur in the presence of water. The treatment composition may be diluted with water to form a treatment liquor. The treatment composition may be diluted from about 100-fold to about 1500-fold, preferably from 300-fold to about 1000-fold.

Liquors that comprise the disclosed compositions may have a pH of from about 3 to about 11.5. When diluted, such compositions are typically employed at concentrations of from about 500 ppm to about 15,000 ppm in solution. When the wash solvent is water, the water temperature typically ranges from about 5° C. to about 90° C. and, the water to fabric ratio may be typically from about 1:1 to about 30:1.

The dilution may occur in the drum of an automatic washing machine. The treatment composition may be placed into a dispensing drawer of an automatic washing machine. The treatment composition may be dispensed from the dispensing drawer to the drum during a treatment process.

As alluded to above, the method may further comprise a step of drying the fabric that has the one or more delivery particles on the surface of the fabric. The drying step may comprise a passive drying process, such as on a clothesline or drying rack. The drying step may comprise an automatic drying process, such as in an automatic dryer machine.

### COMBINATIONS

Specifically contemplated combinations of the disclosure are herein described in the following lettered paragraphs. These combinations are intended to be illustrative in nature and are not intended to be limiting.
A. A treatment composition comprising a treatment adjunct and a population of delivery particles, wherein the delivery particles comprise a core and shell surrounding the core, wherein the core comprises a benefit agent, wherein the shell comprises a polymeric material that is the reaction product of a modified chitosan and at least one electrophile, wherein the modified chitosan comprises the reaction product of chitosan and a modifying compound, wherein the modifying compound comprises an epoxide, an aldehyde, or an α,β-unsaturated compound.
B. The treatment composition according to paragraph A, wherein the modifying compound comprises a cationic group, an anionic group, a nonionic group, or a mixture thereof.
C. The treatment composition according to any of paragraph A or B, wherein the modifying compound comprises a cationic group, an anionic group, or a mixture thereof, more preferably comprises an anionic group.
D. The treatment composition according to any of paragraphs A-C, wherein the modifying compound comprises an acidic group, a hydroxyl group, a quaternary ammonium group, or a mixture thereof, preferably an acidic group.
E. The treatment composition according to any of paragraphs A-D, wherein the modifying compound comprises an α,β-unsaturated compound, preferably wherein the α,β-unsaturated compound is an α,β-unsaturated carbonyl compound.
F. The treatment composition according to any of paragraphs A-E, wherein the modifying compound comprises an α,β-unsaturated compound, wherein the α,β-unsaturated compound is selected from the group consisting of an acrylate, an alkyl acrylate, an α,β-unsaturated ester, an acrylic acid, an acrylamide, a vinyl ketone, a vinyl sulfone, a vinyl phosphonate, an acrylonitrile, or a combination thereof, preferably wherein the α,β-unsaturated compound is selected from group consisting of acrylic acid, acrylate salt, acrylate, alkyl acrylate, an α,β-unsaturated ester, maleic acid, vinyl sulfonic acid, 2-carboxyethyl acrylate, 2-(2-oxo-1-imidazolidinyl)ethyl methacrylate, 2-(2-oxo-1-imidazolidinyl)ethyl methacrylamide, (2-(acryloyloxy)ethyl)trimethylammonium salt, (3-(methacryloylamino)propyl) trimethylammonium salt, N,N-dialkylaminoalkyl acrylate, N,N-dialkylaminoalkyl acrylamide, (3-acrylamidopropyl)trimethylammonium salt, acrylamide, acrylamide salt, 3-sulfopropyl acrylate salt, 2-acrylamido-2-methyl-1-propanesulfonic acid and their salts, quaternized vinyl imidazole, diallyl dialkyl ammonium salts, vinyl amine, vinyl ketone, vinyl sulfone, vinyl phosphonate, acrylonitrile, and combinations thereof.
G. The treatment composition according to any of paragraphs A-F, wherein the modifying compound comprises a material selected from the group consisting of glycidyl trimethylammonium salt, glycidyl isopropyl ether, glycidyl methacrylate, furfuryl glycidyl ether, glycidol, 1,4-butanediol diglycidyl ether, 2-ethylhexyl glycidyl ether, (3-glycidyloxypropyl) trimethoxysilane, poly(ethylene glycol) diglycidyl ether, trimethylolpropane triglycidyl ether, glutaraldehyde, alginate aldehyde, acrylic acid, acrylate salt, maleic acid, vinyl sulfonic acid, 2-carboxyethyl acrylate, 2-(2-oxo-1-imidazolidinyl)ethyl methacrylate, 2-(2-oxo-1-imidazolidinyl)ethyl methacrylamide, (2-(acryloyloxy)ethyl)trimethylammonium salt, (3-(methacryloylamino)propyl) trimethylammonium salt, N,N-dialkylaminoalkyl acrylate, N,N-dialkylaminoalkyl acrylamide, (3-Acrylamidopropyl)trimethylammonium salt, 3-sulfopropyl acrylate salt, 2-acrylamido-2-methyl-1-propanesulfonic acid and their salts, quaternized vinyl imidazole, diallyl dialkyl ammonium salts, vinyl amine, and combinations thereof.
H. The treatment composition according to any of paragraphs A-G, wherein the chitosan comprises free amine moieties, and wherein the molar ratio of the modifying compound to the free amine moieties of the chitosan is from 0.1% to 100%, preferably from 10% to 100%, more preferably from 10% to 90%, even more preferably from 25% to 90%, even more preferably from 25% to 75%.
I. The treatment composition according to any of paragraphs A-H, wherein the shell comprises at least 18%, preferably at least 21%, by weight of the shell, of the modified chitosan.
J. The treatment composition according to any of paragraphs A-I, wherein the modified chitosan is characterized by a weight average molecular weight of from about 100 kDa to about 600 kDa, preferably a weight average molecular weight of from about 100 kDa to about 500 kDa, more preferably from about 100 kDa to about 400 kDa, more preferably from about 100 kDa to about 300 kDa, even more preferably from about 100 kDa to about 200 kDa.
K. A treatment composition comprising a treatment adjunct and a population of delivery particles, wherein the delivery particles comprise a core and shell surrounding the core, wherein the core comprises a benefit agent, wherein the shell comprises a polymeric material that is a reaction product of at least one modified chitosan and at least one electrophile, wherein the population of delivery particles is obtainable a process comprising the following steps: forming a water phase by dissolving or dispersing chitosan in an aqueous acidic medium at a pH of 6.5 or less and a temperature of at least 25° C., the chitosan having free amine moieties; forming an oil phase comprising combining together at least one benefit agent and at least one electrophile, preferably at least one polyisocyanate, optionally with an added oil; forming an emulsion by mixing under high shear agitation the oil phase into an excess of the water phase, thereby forming droplets of the oil phase dispersed in the water phase; adding to the water phase and/or to the emulsion, preferably at least to the water phase, a modifying compound, the modifying compound comprising one or more of an epoxide, an aldehyde, or an α,β-unsaturated compound, the modifying compound reacting with the free amine moieties of the chitosan; optionally adjusting the pH of the emulsion to a pH of 4 or greater; heating the emulsion to at least 40° C., for a time sufficient to form a shell at an interface of the droplets with the water phase, the shell surrounding the core.
L. A treatment composition comprising a treatment adjunct and a population of delivery particles, wherein the delivery particles comprise a core and shell surrounding the core, wherein the core comprises a benefit agent, wherein the shell comprises a polymeric material that is a reaction product of at least one modified chitosan and at least one electrophile, the modified chitosan comprising a reaction product of chitosan and a modifying compound, wherein the modifying compound comprises an epoxide, an aldehyde, or an α,β-unsaturated compound that covalently bonds with the chitosan, wherein the population of delivery particles is obtainable a process comprising the following steps: dissolving or dispersing chitosan into a water phase, the chitosan having amine moieties; combining the water phase and the modifying compound; optionally adjusting the pH of the water phase to pH 3.0 or higher, preferably from pH 3.0 to pH 6; optionally adjusting the temperature of the water phase to 25° C. or greater; mixing the water phase for a period of time, thereby forming a modified chitosan, wherein the modifying compound is covalently bonded through CN bonds with the amine moieties of the chitosan, wherein the modified chitosan remains dissolved in the water phase; providing an oil phase comprising dissolving together at least one benefit agent comprising an oil, and at least one electrophile, preferably at least one polyisocyanate, optionally with a second oil; forming an emulsion by mixing under high shear agitation the oil phase into the water phase, thereby forming droplets of the oil phase and benefit agent dispersed in the water phase; heating the emulsion to at least 40° C., for a time sufficient to form the shell at an interface of the droplets with the water phase, the shell surrounding the core.
M. The treatment composition according to any of paragraphs A-L, wherein the process by which the population of delivery particles is obtainable further comprises the step of adding a redox initiator to the water phase or the emulsion, wherein the redox initiator comprises a persulfate, a peroxide, or a combination thereof.
N. The treatment composition according to any of paragraphs A-M, wherein the modifying compound comprises a cationic group and/or an anionic group.
O. The treatment composition according to any of paragraphs A-N, wherein the delivery particles comprise from about 1% to about 25%, by weight of the delivery particles, of the shell.
P. The treatment composition according to any of paragraphs A-O, wherein the shell degrades at least 50%, preferably at least 60%, after 60 days when tested according to test method OECD 301B.
Q. The treatment composition according to any of paragraphs A-P, wherein the delivery particles are characterized by a zeta potential of 150 mV or less at pH 4.5.
R. The treatment composition according to any of paragraphs A-R, wherein the electrophile comprises a polyisocyanate, preferably a polyisocyanate selected from the group consisting of: a polyisocyanurate of toluene diisocyanate; a trimethylol propane adduct of toluene diisocyanate; a trimethylol propane adduct of xylylene diisocyanate; 2,2′-methylenediphenyl diisocyanate; 4,4′-methylenediphenyl diisocyanate; 2,4′-methylenediphenyl diisocyanate; [diisocyanato(phenyl)methyl]benzene; toluene diisocyanate; tetramethylxylidene diisocyanate; naphthalene-1,5-diisocyanate; 1,4-phenylene diisocyanate; 1,3-diisocyanatobenzene; derivatives thereof (such as pre-polymers, oligomers, and/or polymers thereof); and combinations thereof.
S. The treatment composition according to any of paragraphs A-R, wherein the benefit agent is a fragrance material.
T. The treatment composition according to any of paragraphs A-S, wherein the core further comprises a partitioning modifier, optionally present in the core at a level of from about 5% to about 55%, preferably from about 10% to about 50%, more preferably from about 25% to about 50%, by weight of the core, preferably a partitioning modifier selected from the group consisting of vegetable oil, modified vegetable oil, mono-, di-, and tri-esters of C₄-C₂₄ fatty acids, isopropyl myristate, dodecanophenone, lauryl laurate, methyl behenate, methyl laurate, methyl palmitate, methyl stearate, and mixtures thereof, more preferably isopropyl myristate.
U. The treatment composition according to any of paragraphs A-T, wherein the delivery particles are characterized by a volume-weighted median particle size from about 1 to about 100 microns, preferably from about 10 to about 100 microns, preferably from about 15 to about 50 microns, more preferably from about 20 to about 40 microns, even more preferably from about 25 to about 35 microns.
V. The treatment composition according to any of paragraphs A-U, wherein the treatment adjunct is selected from the group consisting of surfactants, conditioning actives, deposition aids, rheology modifiers or structurants, bleach systems, stabilizers, builders, chelating agents, dye transfer inhibiting agents, dispersants, enzymes, enzyme stabilizers, catalytic metal complexes, polymeric dispersing agents, clay and soil removal/anti-redeposition agents, brighteners, suds suppressors, silicones, hueing agents, aesthetic dyes, neat perfume, additional perfume delivery systems, structure elasticizing agents, carriers, hydrotropes, processing aids, anti-agglomeration agents, coatings, formaldehyde scavengers, pigments, and mixtures thereof.
W. The treatment composition according to any of paragraphs A-V, wherein the treatment adjunct comprises anionic surfactant, a cationic conditioning agent, or a mixture thereof.
X. The treatment composition according to any of paragraphs A-W, wherein the treatment composition is a fabric care composition, a hard surface cleaner composition, a dish care composition, a hair care composition, a body cleansing composition, or a mixture thereof, preferably a fabric care composition, more preferably a fabric care composition that is a laundry detergent composition, a fabric conditioning composition, a laundry additive, a fabric pre-treat composition, a fabric refresher composition, or a mixture thereof.
Y. The treatment composition according to any of paragraphs A-X, wherein the treatment composition is in the form of a liquid composition, a granular composition, a hydrocolloid, a single-compartment pouch, a multi-compartment pouch, a dissolvable sheet, a pastille or bead, a fibrous article, a tablet, a stick, a bar, a flake, a foam/mousse, a non-woven sheet, or a mixture thereof, preferably a single-compartment pouch, a multi-compartment pouch, a pastille or bead, or a mixture thereof.
Z. The treatment composition according to any of paragraphs A-Y, wherein the treatment composition comprises less than about 25% water, preferably less than about 20% water, more preferably less than about 15% water, even more preferably less than about 12% water, even more preferably less than about 10% water, even more preferably less than about 5% water, by weight of the treatment composition.
AA. A method of making a treatment composition according to any of paragraphs A-Z, the method comprising the steps of: providing a base composition, wherein the base composition comprises the treatment adjunct, and combining the population of delivery particles with the base composition.
BB. The method according to paragraph AA, wherein the population of delivery particles is provided as an aqueous slurry.
CC. The method according to paragraph BB, wherein the aqueous slurry comprises less than about 25% water, preferably less than about 20% water, more preferably less than about 15% water, even more preferably less than about 12% water, even more preferably less than about 10% water, even more preferably less than about 5% water, by weight of the aqueous slurry.
DD. The method according to any of paragraphs AA-CC, wherein the base composition is in the form of a liquid composition.
EE. A method of treating a surface, the method comprising the step of: contacting the surface, preferably a fabric, with a treatment composition according to any of paragraphs A-Z.

### TEST METHODS

It is understood that the test methods disclosed in the Test Methods section of the present application should be used to determine the respective values of the parameters of Applicant's claimed subject matter as claimed and described herein.

### Determination of a Polymer's Molecular Weight and Related Parameters

The following method describing gel permeation chromatograph with multi-angle light scatter and refractive index detection (GPC-MALS/RI) is used to find molecular weight distribution measurements and related values of the polymers described herein.

Gel Permeation Chromatography (GPC) with Multi-Angle Light Scattering (MALS) and Refractive Index (RI) Detection (GPC-MALS/RI) permits the measurement of absolute molecular weight of a polymer without the need for column calibration methods or standards. The GPC system allows molecules to be separated as a function of their molecular size. MALS and RI allow information to be obtained on the number average (Mn) and weight average (Mw) molecular weight.

The Mw distribution of water-soluble polymers like chitosan is typically measured by using a Liquid Chromatography system (e.g., Agilent 1260 Infinity pump system with OpenLab Chemstation software, Agilent Technology, Santa Clara, CA, USA) and a column set (e.g., 2 Tosoh TSKgel G6000WP 7.8×300mm 13um pore size, guard column A0022 6mm×40mm PW x1-cp, King of Prussia, PA) which is operated at 40° ° C. The mobile phase is 0.1M sodium nitrate in water containing 0.02% sodium azide and 0.2% acetic acid. The mobile phase solvent is pumped at a flow rate of 1 mL/min, isocratically. A multiangle light scattering (18-Angle MALS) detector DAWN® and a differential refractive index (RI) detector (Wyatt Technology of Santa Barbara, Calif., USA) controlled by Wyatt Astra® software v8.0 are used.

A sample is typically prepared by dissolving chitosan materials in the mobile phase at ˜1 mg per ml and by mixing the solution for overnight hydration at room temperature. The sample is filtered through a 0.8 μm Versapor membrane filter (PALL, Life Sciences, NY, USA) into the LC autosampler vial using a 3-ml syringe before the GPC analysis.

A dn/dc value (differential change of refractive index with concentration, 0.15) is used for the number average molecular weight (Mn), weight average molecular weight (Mw), Z-average molecular weight (Mz), molecular weight of the peak maxima (Mp), and polydispersity (Mw/Mn) determination by the Astra detector software.

### Viscosity

Viscosity of liquid finished product is measured using an AR 550 rheometer/viscometer from TA instruments (New Castle, DE, USA), using parallel steel plates of 40 mm diameter and a gap size of 500 μm. The high shear viscosity at 20 s⁻¹ and low shear viscosity at 0.05 s⁻¹ is obtained from a logarithmic shear rate sweep from 0.01 s⁻¹ to 25 s⁻¹ in 3 minutes time at 21° C.

### Test Method for Determining log P

The value of the log of the Octanol/Water Partition Coefficient (log P) is computed for each material (e.g., each PRM in the perfume mixture) being tested. The log P of an individual material (e.g., a PRM) is calculated using the Consensus log P Computational Model, version 14.02 (Linux) available from Advanced Chemistry Development Inc. (ACD/Labs) (Toronto, Canada) to provide the unitless log P value. The ACD/Labs' Consensus log P Computational Model is part of the ACD/Labs model suite.

### Volume-Weighted Particle Size and Size Distribution

The volume-weighted particle size distribution is determined via single-particle optical sensing (SPOS), also called optical particle counting (OPC), using the AccuSizer 780 AD instrument and the accompanying software CW788 version 1.82 (Particle Sizing Systems, Santa Barbara, California, U.S.A.), or equivalent. The instrument is configured with the following conditions and selections: Flow Rate=1 ml/sec; Lower Size Threshold=0.50 um; Sensor Model Number=Sensor Model Number=LE400-05 or equivalent; Autodilution=On; Collection time=60 sec; Number channels=512; Vessel fluid volume=50 ml; Max coincidence=9200 . The measurement is initiated by putting the sensor into a cold state by flushing with water until background counts are less than 100. A sample of delivery capsules in suspension is introduced, and its density of capsules adjusted with DI water as necessary via autodilution to result in capsule counts of at least 9200 per ml. During a time period of 60 seconds the suspension is analyzed. The resulting volume-weighted PSD data are plotted and recorded, and the values of the desired volume-weighted particle size (e.g., the median/50^{th} percentile, 5^{th} percentile, and/or 90^{th} percentile) are determined.

### Procedure for Determination of % Degradation

To determine % degradation, the procedure set forth in the “OECD Guideline for Testing of Chemicals” 301B CO₂ Evolution (Modified Sturm Test), adopted 17 Jul. 1992, is used. For ease of reference, this test method is referred to herein as test method OECD 301B.

### Fabric Treatment Method

Miele washing machines were used to treat the fabrics. For each treatment, the washing machine was loaded with 3kg fabric, comprising 1100 g knitted cotton fabric, 1100 g polyester-cotton fabrics (50/50). Additionally, 18 terry towel cotton tracers are also added, which weigh together about 780 g.

Prior to the test treatment, the load is preconditioned twice, each time using the 95° C. short cotton cycle with 79 g of unperfumed IEC A Base detergent (ex WFK Testgewebe GmbH), followed by two additional 95° C. washes without detergent.

For the test treatment, the load is washed using a 40° C. short cotton cycle, 1200 rpm spin speed with 79 g IEC A Base detergent, which is added at the start of the wash cycle in the appropriate dispenser. A dosage of 35 g of the test fabric treatment composition (i.e., LFE according to the examples) is added in the appropriate dispenser. At the end of the treatment cycle, the terry towel tracers are removed from the washing machine and line-dried overnight.

The next day, the dry terry towel tracers are analyzed by fast headspace GC/MS (gas chromatography mass spectrometry) approach, as described below. All treatments washed at the same day for comparative purpose and analyzed on the same day are reported as “one wash test.”

### Method to Determine Headspace Concentration Above Treated Dry Fabrics

The cotton tracers are analyzed by a fast headspace GC/MS (gas chromatography mass spectrometry) approach. 4×4 cm aliquots of the terry towel cotton tracers were transferred to 25 ml headspace vials. The fabric samples were equilibrated for 10 minutes@65° C. The headspace above the fabrics was sampled via SPME (50/30 μm DVB/Carboxen/PDMS) approach for 5 minutes. The SPME fiber was subsequently on-line thermally desorbed into the GC. The analytes were analyzed by fast GC/MS in full scan mode. Ion extraction of the specific masses of the PRMs was used to calculate the total HS response and perfume headspace composition above the tested legs.

### Procedure for Determination of Quantity of Free Oil (“QFO”)

This method measures the amount of oil (i.e., the quantity of free oil, or “QFO”) in the water phase and uses as an internal standard solution 1 mg/ml dibutyl phthalate (DBP)/hexane.

Weigh a little more than 250 mgs of DBP into a small beaker and transfer to a 250 ml volumetric rinsing the beaker thoroughly. Fill with hexane to 250 ml.

Sample Prep: Weigh approximately 1.5-2 grams (40 drops) of the capsule slurry into a 20 ml scintillation vial and add 10 ml's of the ISTD solution, cap tightly. Shaking vigorously several times over 30 minutes, pipette solution into an autosampler vial and analyze by GC.

Additional details. Instrumentation: HP5890 GC connected to HP Chem Station Software; Column: 5 m×0.32 mm id with 1 μm DB-1 liquid phase; Temperature 50 deg for 1 minute then heat to 320 deg@15 deg/min; Injector: 275° C.; Detector: 325° C.; 2 ul injection.

Calculation: Add total peak area minus the area for the DBP for both the sample and calibration.

$$Calculate mg of free core oil : \frac{Total area from sample}{Total area from calibration} \times mg of oil in calibration solution = mg of free core oil \\ Calculate \% free core oil : \frac{mg of free core oil}{Sample wt . ( mg )} \times 100 = \% free core oil in wet slurry$$

### Procedure for Determination of Benefit Agent Leakage

Obtain two 1-gram samples of benefit agent particle composition. Add 1 gram (Sample 1) of particle composition to 99 grams of product matrix in which the particle will be employed. Age the particle containing product matrix (Sample 1) for 2 weeks at 35° C. in a sealed glass jar. The other 1 gram sample (Sample 2) is similarly aged.

After 2 weeks, use filtration to recover the particle composition's particles from the product matrix (Sample 1) and from the particle composition (Sample 2). Treat each particle sample with a solvent that will extract all the benefit agent from each samples' particles. Inject the benefit agent containing solvent from each sample into a Gas Chromatograph and integrate the peak areas to determine the total quantity of benefit agent extracted from each sample.

Determine the percentage of benefit agent leakage by calculating the difference in the values obtained for the total quantity of benefit agent extracted from Sample 2 minus Sample 1, expressed as a percentage of the total quantity of benefit agent extracted from Sample 2, as represented in the equation below:

$$Percentage of Benefit Agent Leakage = ( \frac{Sample 2 - Sample 1}{Sample 2} ) \times 100$$

### Procedure for Qualitatively Measuring Compatibility of Delivery Particles in Laundry Matrix

The compatibility of the delivery particles in laundry matrix is measured by visually inspect the mixture of delivery particles and laundry matrix in glass jar. The slurry containing the delivery particles were homogenized by agitation for at least one minutes with an overhead mixer. The homogenized slurry was then added in laundry matrix, such as heavy duty laundry matrix at a ratio of 1:40, such as 1 g slurry in 40 g matrix, under mixing. Mixing the above mixture for at least 15 minutes at 350 rpm using overhead mixer. Stop mixing and let the mixture stand for 5 minutes before examination. Visually inspect the mixture with naked eye and under optical microscope to detect any aggregates in the mixture. If any aggregates observed with naked eye or greater than 100 micron under optical microscope, the delivery particles are determined to be not compatible in laundry matrix.

### EXAMPLES

The examples provided below are intended to be illustrative in nature and are not intended to be limiting.

In the following examples, the abbreviations correspond to the materials listed in Table 1. Comparative Example 1 discloses the synthesis of comparative delivery particles. Examples 1-7 disclose the synthesis of delivery particles according to the present disclosure in which the chitosan is modified in the water phase. Examples 7-21 disclose the synthesis of delivery particles according to the present disclosure in which the chitosan is modified at the emulsion stage.

TABLE 1

| Trade Name | Material | Company/City |
|---|---|---|
| Selvol 540 | Polyvinyl alcohol | Sekisui Specialty Chemicals, |
| | | Dallas, TX |
| ChitoClear | Chitosan | Primex EHF, Siglufjordur, |
| | | Iceland |
| Takenate D- | Polyisocyanate | Mitsui Chemicals America, |
| 110N | prepolymer | Inc., |
| | | Rye Brook, NY |
| CD9055 | Acidic acrylate oligomer | Arkema Inc., King of |
| | | Prussia, Pennsylvania |
| SR444 | Pentaerythritol triacrylate | Arkema Inc., King of |
| | | Prussia, Pennsylvania |
| SR268 | Tetraethylene glycol diacrylate | Arkema Inc., King of |
| | | Prussia, Pennsylvania |
| Caustic soda | Sodium hydroxide | Hydrite Chemical Co., |
| | | Brookfield, WI |
| HCl | Hydrochloric acid | Avantor Performance |
| | | Materials, LLC, Radnor, PA |
| | [2-(Acryloyloxy)ethyl]trimethylammonium | Sigma-Aldrich Inc., St. |
| | chloride solution | Louis, MO |
| | Glacial acetic acid | Avantor Performance |
| | | Materials, LLC, Radnor, PA |
| | Isopropyl myristate | Acme-Hardesty Co., Bule |
| | | Bell, PA |
| | Acrylic acid | TCI America, Portland, OR |
| | 3-Sulfopropyl acrylate potassium salt | Sigma-Aldrich Inc., St. |
| | | Louis, MO |
| | Potassium persulfate | Avantor Performance |
| | | Materials, LLC, Radnor, PA |

### Comparative Example 1. Polyurea Capsule with (Unmodified) Chitosan

A chitosan stock solution is prepared by dispersing 39.60 g chitosan Chitoclear into 840.4 g deionized water while mixing in a jacketed reactor. The pH of the chitosan dispersion is then adjusted to 3.87 using 17.90 g concentrated HCl under agitation. The temperature of the chitosan solution is then increased to 85° C. over 60 minutes and then held at 85° C. for 2 hours to hydrolyze the ChitoClear. The temperature is then reduced to 25° C. after the hydrolyzing step over a period of 90 minutes. The pH of the acid-treated chitosan solution is 3.97.

A water phase is prepared by mixing 426.30 g of the above chitosan stock solution and 6.70 g 5% PVA540 solution in a jacketed reactor. An oil phase is prepared by mixing 146.63 g perfume and 36.66 g isopropyl myristate together along with 4.00 g Takenate D-110N at room temperature. The oil phase is added to the water phase under high shear milling to obtain an emulsion with desired particle size. The emulsion is heated to 40° C. in 30 minutes and then hold at 40° C. for 60 minutes. The emulsion is then heated to 85° C. in 60 minutes and maintained at this temperature for 6 hours while mixing. The formed capsules have a median particle size of 8.05 micron. The capsules formed had a one week leakage of 20.78%. The prepared slurry shows aggregation in heavy duty liquid laundry matrix.

### Example 1. Pre-Modified with [2-(Acryloyloxy)ethyl]trimethylammonium Chloride

A modified chitosan solution was prepared by dispersing 40.92 g chitosan powder in 792.00 water at 70° C. The pH of the above mixture was adjusted to 4.91 using 9.79 g glacial acetic acid. 46.36 g 80% [2-(Acryloyloxy)ethyl]trimethylammonium chloride solution was then added to the above chitosan solution and mixed at 70° C. for 12 hours to obtain the [2-(Acryloyloxy)ethyl]trimethylammonium chloride modified chitosan solution. The pH of the obtained modified chitosan solution is 4.05.

A water phase is prepared by weighting 255.8 g [2-(Acryloyloxy)ethyl]trimethylammonium chloride modified chitosan solution in jacketed reactor at 25° C.

An oil phase is prepared by mixing 87.98 g perfume, 2.40 g Takenate D110 and 22.00 g Isopropyl myristate at 25° C. in a beaker.

The oil phase is added into the water phase under high shear for a period of time to obtain an emulsion at room temperature.

The emulsion is then heated to 40° C. in 30 minutes and then hold at 40° C. for 60 minutes. The emulsion is then heated to 85° C. in 60 minutes and hold for 6 hours to cure the wall. The emulsion is then cooled down to 25° C. in 90 minutes. The obtained capsule has median particle size of 12.27 micron. The QFO and 1 week leakage of the capsule slurry is 7.69% and 68.59% respectively. The prepared slurry shows no aggregation in heavy duty liquid laundry matrix.

### Example 2. Pre-Modified with [2-(Acryloyloxy)ethyl]trimethylammonium Chloride and pH Adjustment

Example 2 is prepared following the procedure of example 1 beside the pH of the water phase was adjusted to 6.8 using sodium hydroxide solution. The water phase is still clear after pH adjustment. The obtained capsule has median particle size of 36.44 micron. The QFO and 1 week leakage of the capsule slurry is 0.11% and 0.99% respectively. The prepared slurry shows no aggregation in heavy duty liquid laundry matrix.

### Example 3. Pre-Modified with [2-(Acryloyloxy)ethyl]trimethylammonium Chloride and pH Adjustment and 2^{nd} Crosslinker (pentaerythritol triacrylate)

A modified chitosan solution is prepared according to the procedures in Example 1. The modified chitosan solution has pH of 4.10. A water phase is comprised of the modified chitosan solution with pH adjusted to 9.35 using sodium hydroxide solution.

An emulsion is prepared according to example 1 and then heated to 70° C. before a 2^{nd} crosslinker, pentaerythritol triacrylate, was added to the emulsion at 70° C. The emulsion was then heated to 90° C. in 60 minutes and hold at another 8 hours before cooled down to 25° C. to finish the curing process. The obtained capsule has median particle size of 23.63 micron. The QFO and 1 week leakage of the capsule slurry is 0.35% and 6.19% respectively. The prepared slurry shows no aggregation in heavy duty liquid laundry matrix.

### Example 4. Pre-Modified with CD9055, Acidic Acrylate Oligomer

A modified chitosan solution was prepared by dispersion 42.11 g chitosan powder in 840.00 g water at 70° ° C. 42.11 g CD9055, an acidic acrylate oligomer was then added to the above chitosan mixture and mixed at 70° C. for 12 hours to obtain CD9055 modified chitosan solution. The pH of the obtained modified chitosan solution is 4.08.

A water phase is prepared by weighting 328.00 g CD9055 modified chitosan solution in jacketed reactor at 25° C.

An oil phase is prepared by mixing 112.82 g perfume, 3.08 g Takenate D110 and 28.21 g Isopropyl myristate at 25° C. in a beaker.

The oil phase is added into the water phase under high shear for a period of time to obtain an emulsion at room temperature.

The emulsion is then heated to 40° C. in 30 minutes and then hold at 40° C. for 60 minutes. The emulsion is then heated to 85° C. in 60 minutes and hold for 6 hours to cure the wall. The emulsion is then cooled down to 25° C. in 90 minutes. The obtained capsule has median particle size of 37.74 micron. The QFO and 1 week leakage of the capsule slurry is 0.83% and 41.46% respectively.

### Example 5. Pre-Modified with CD9055, Acidic Acrylate Oligomer and pH Adjustment

A water phase is prepared by weighting 255.78 g CD9055 modified chitosan solution from Example 4 in jacketed reactor at 25° C. The pH of the water phase was then adjusted to 8.23 using sodium hydroxide. The water phase is still clear after pH adjustment.

An oil phase is prepared by mixing 87.98 g perfume, 2.40 g Takenate D110 and 22.00 g Isopropyl myristate at 25° C. in a beaker.

The oil phase is added into the water phase under high shear for a period of time to obtain an emulsion at room temperature.

The emulsion is then heated to 40° C. in 30 minutes and then hold at 40° C. for 60 minutes. The emulsion is then heated to 85° C. in 60 minutes and hold for 6 hours to cure the wall. The emulsion is then cooled down to 25° C. in 90 minutes. The obtained capsule has median particle size of 25.72 micron. The QFO and 1 week leakage of the capsule slurry is 0.28% and 6.95% respectively. The prepared slurry shows no aggregation in heavy duty liquid laundry matrix.

### Example 6. Pre-Modified with CD9055, Acidic Acrylate Oligomer, and 2nd Modifying Compound-Pentaerythritol Triacrylate

A modified chitosan solution is prepared by dispersing 42.11 g chitosan in 840 g water at 70° C. The pH of the above mixture was adjusted to 4.86 using 11.26 g glacial acetic acid. 35.85 g CD9055 was then added to the above chitosan solution and mixed at 70° C. for 12 hours to obtain the CD9055 modified chitosan solution. The pH of the obtained modified chitosan solution is 3.90.

A water phase is prepared by adding 266.70 g CD9055 modified chitosan solution in a jacketed reactor.

An oil phase is prepared by mixing 99.71 g perfume, 2.72 g Takenate D110 and 24.93 g Isopropyl myristate at 25C in a beaker.

The oil phase is added into the water phase under high shear for a period of time to obtain an emulsion at room temperature.

The obtained emulsion is then heated to 70° C. before a 2^{nd} crosslinker, pentaerythritol triacrylate, was added to the emulsion at 70° C. The emulsion was then heated to 90° C. in 60 minutes and hold at another 8 hours before cooled down to 25° C. to finish the curing process. The obtained capsule has median particle size of 27.52 micron. The QFO and 1 week leakage of the capsule slurry is 0.10% and 34.40% respectively.

### Example 7. Pre-Modified with CD9055, Acidic Acrylate Oligomer and a 2^{nd} Modifying Compound

A modified chitosan solution was prepared by dispersion 42.11 g chitosan powder in 840.00 g water at 70° ° C. 42.11 g CD9055, an acidic acrylate oligomer was then added to the above chitosan mixture and mixed at 70° C. for 12 hours to obtain CD9055 modified chitosan solution. The pH of the obtained modified chitosan solution is 4.08.

A water phase is prepared by weighting 255.78 g CD9055 modified chitosan solution in jacketed reactor at 25° C.

An oil phase is prepared by mixing 87.98 g perfume, 2.40 g Takenate D110 and 22.00 g Isopropyl myristate at 25° C. in a beaker.

The oil phase is added into the water phase under high shear for a period of time to obtain an emulsion at room temperature. The pH of the emulsion is adjusted to 9.07 using sodium hydroxide solution at 40° C.

The emulsion is then heated to 40° C. in 30 minutes and the pH of the emulsion is adjusted to 9.07 using sodium hydroxide solution. The emulsion is then hold at 40° C. for 60 minutes and then heated to 85° C. in 60 minutes and hold for 6 hours to cure the wall. The emulsion is then cooled down to 25° ° C. in 90 minutes. The obtained capsule has median particle size of 25.95 micron. The QFO and 1 week leakage of the capsule slurry is 0.66% and 24.91% respectively. The prepared slurry shows no aggregation in heavy duty liquid laundry matrix.

### Example 8. Crosslinked Chitosan Capsule In-Situ Modified with CD9055, Acidic Acrylate Oligomer

A chitosan solution is prepared as in Comparative example 1, but the pH of the chitosan solution is at 5.23.

A water phase is prepared by adding 308.70 g above chitosan solution in a jacketed reactor at 25° C.

An oil phase is prepared by mixing 102.64 g perfume, 2.80 g Takenate D110 and 25.66 g Isopropyl myristate at 25° C. in a beaker.

The oil phase is added into the water phase under high shear for a period of time to obtain an emulsion at room temperature.

The obtained emulsion is then heated to 70° C. before a modifying compound, 10.71 g CD9055 was added to the emulsion at 70° C. The emulsion was then heated to 90° C. in 60 minutes and hold at another 8 hours before cooled down to 25° C. to finish the curing process. The obtained capsule has median particle size of 30.22 micron. The QFO and 1 week leakage of the capsule slurry is 0.49% and 48.08% respectively.

### Example 9. Crosslinked Chitosan Capsule In-Situ Modified with [2-(Acryloyloxy)ethyl]trimethylammonium Chloride

A chitosan solution is prepared as in Comparative example 1, but pH of the chitosan solution is at 5.23.

A water phase is prepared by adding 308.70 g above chitosan solution in a jacketed reactor at 25° C.

An oil phase is prepared by mixing 102.64 g perfume, 2.80 g Takenate D110 and 25.66 g Isopropyl myristate at 25° C. in a beaker.

The oil phase is added into the water phase under high shear for a period of time to obtain an emulsion at room temperature.

The obtained emulsion is then heated to 70° ° C. before a modifying compound, 17.92 g 80% [2-(Acryloyloxy)ethyl]trimethylammonium chloride solution was added to the emulsion at 70° C. The emulsion was then heated to 90° C. in 60 minutes and hold at another 8 hours before cooled down to 25° C. to finish the curing process. The obtained capsule has median particle size of 27.84 micron. The QFO and 1 week leakage of the capsule slurry is 0.29% and 4.62% respectively. The prepared slurry shows no aggregation in heavy duty liquid laundry matrix.

### Example 10. Crosslinked Chitosan Capsule In-Situ Modified with 25% Molar Acrylic Acid

A chitosan stock solution is prepared by dispersing 155.7 g chitosan Chitoclear into 3304 g deionized water while mixing in a jacketed reactor. The pH of the chitosan dispersion is then adjusted to 5.23 using 69.84 g concentrated HCl (31%) under agitation. The temperature of the chitosan solution is then increased to 65° C. over 30 minutes, then to 85° C. in 30 minutes, then to 95° C. in 30 minutes, and then held at 95° C. for 2 hours to hydrolyze the ChitoClear. The temperature is then reduced to 25° C. after the hydrolyzing step over a period of 90 minutes. The pH of the hydrolyzed chitosan solution is 5.31.

A water phase is prepared by mixing 433.6 g of the above chitosan stock solution and in a jacketed reactor at 25° C. An oil phase is prepared by mixing 128.9 g perfume and 32.2 g isopropyl myristate together along with 4.88 g Takenate D-110N at room temperature. The oil phase is added to the water phase under high shear milling to obtain an emulsion with desired particle size. The emulsion is heated to 60° C. in 45 minutes, then to 95° C. in 60 minutes. Once at 95° C., a solution of 2.07 g acrylic acid (TCI Chemical #A0141), 2.07 g RO water, and 5.08 g 21.5% NaOH (prepared in ice bath) added to slurry and then hold at 95° C. for 360 minutes. The temperature is then reduced to 25° C. in 90 minutes. The formed capsules have a median particle size of 30.42 micron.

### Example 11. Crosslinked Chitosan Capsule In-Situ Modified with 100% Molar Acrylic Acid

A crosslinked chitosan capsule slurry is prepared the same as Example 10, except with a solution of 8.29 g acrylic acid (TCI Chemical #A0141), 8.29 g RO water, and 20.31 g 21.5% NaOH (prepared in ice bath) added once at 95° C., instead of a solution of 2.07 g acrylic acid (TCI Chemical #A0141), 2.07 g RO water, and 5.08 g 21.5% NaOH. The formed capsules have a median particle size of 31.25 micron.

### Example 12. Crosslinked Chitosan Capsule In-Situ Modified with 100% Molar Acrylic Acid Add at 25° C.

A crosslinked chitosan capsule slurry is prepared the same as Example 10, except with a solution of 8.29 g acrylic acid (TCI Chemical #A0141), 8.29 g RO water, and 20.31 g 21.5% NaOH (prepared in ice bath) added once an emulsion with desired particle size is attained at 25° C., instead of a solution of 2.07 g acrylic acid (TCI Chemical #A0141), 2.07 g RO water, and 5.08 g 21.5% NaOH added at 95° C. The formed capsules have a median particle size of 31.68 micron.

### Example 13. Crosslinked Chitosan Capsule In-Situ Modified with 25% Molar Acrylic Acid and 5% Molar SR268

A crosslinked chitosan capsule slurry is prepared the same as Example 10, except 1.74 g tetraethylene glycol diacrylate (Sartomer #SR268) is also added right after the solution of 2.07 g acrylic acid (TCI Chemical #A0141), 2.07 g RO water, and 5.08 g 21.5% NaOH added once at 95° C. The formed capsules have a median particle size of 30.83 micron.

### Example 14. Crosslinked Chitosan Capsule In-Situ Modified with 25% Molar 3-Sulfopropyl Acrylate Potassium Salt

A crosslinked chitosan capsule slurry is prepared the same as Example 10, except with adding 6.69 g 3-Sulfopropyl acrylate potassium salt (Sigma-Aldrich #251631) once at 95° C., instead of a solution of 2.07 g acrylic acid (TCI Chemical #A0141), 2.07 g RO water, and 5.08 g 21.5% NaOH. The formed capsules have a median particle size of 30.83 micron.

### Example 15. Crosslinked Chitosan Capsule In-Situ Modified with 50% Molar Glycidyl trimethylammonium Chloride Add at 25° C.

A crosslinked chitosan capsule slurry is prepared the same as Example 10, except with 10.92 g 80% Glycidyl trimethylammonium chloride (TCI Chemical #G0476) added once an emulsion with desired particle size is attained at 25° C., instead of a solution of 2.07 g acrylic acid (TCI Chemical #A0141), 2.07 g RO water, and 5.08 g 21.5% NaOH added at 95° C. The formed capsules have a median particle size of 32.98 micron.

### Example 16. Crosslinked Chitosan Capsule In-Situ Modified with 25% Molar Glycidyl trimethylammonium Chloride Add at 95° C.

A crosslinked chitosan capsule slurry is prepared the same as Example 10, except with 5.46 g 80% Glycidyl trimethylammonium chloride (TCI Chemical #G0476) added once at 95° C., instead of a solution of 2.07 g acrylic acid (TCI Chemical #A0141), 2.07 g RO water, and 5.08 g 21.5% NaOH. The formed capsules have a median particle size of 30.84 micron.

### Example 17. Crosslinked Chitosan Capsule In-Situ Modified with 25% Molar Glycidyl trimethylammonium Chloride Add at 25° ° C.

A crosslinked chitosan capsule slurry is prepared the same as Example 10, except with 5.46 g 80% Glycidyl trimethylammonium chloride (TCI Chemical #G0476) added once an emulsion with desired particle size is attained at 25° C., instead of a solution of 2.07 g acrylic acid (TCI Chemical #A0141), 2.07 g RO water, and 5.08 g 21.5% NaOH added at 95° C. The formed capsules have a median particle size of 29.61 micron.

### Example 18. Crosslinked Chitosan Delivery Particles In-Situ Modified with 25% Molar Neutralized CD9055, 13.5% Molar SR268, and 10% Mass KPS of Chitosan

A chitosan stock solution is prepared by dispersing 155.7 g chitosan Chitoclear into 3304 g deionized water while mixing in a jacketed reactor. 1.56 g Potassium Persulfate (KPS) added. The pH of the chitosan dispersion is then adjusted to 5.84 using 57.29 g concentrated HCl under agitation. The temperature of the chitosan solution is then increased to 65° C. over 30 minutes, then to 85° C. in 30 minutes, then to 95° C. in 30 minutes, and then held at 95° C. for 2 hours to hydrolyze the chitosan ChitoClear. The temperature is then reduced to 25° C. after the hydrolyzing step over a period of 90 minutes. The pH of the acid-treated chitosan solution is 5.85.

A water phase is prepared by mixing 390.0 g of the above chitosan stock solution and in a jacketed reactor at 25° C. An oil phase is prepared by mixing 115.9 g perfume and 29.0 g isopropyl myristate together along with 4.40 g Takenate D-110N at room temperature. The oil phase is added to the water phase under high shear milling to obtain an emulsion with desired particle size. The emulsion is heated to 60° C. in 45 minutes, then to 95° C. in 60 minutes. Once at 95° C., a solution of 4.52 g CD9055, 4.52 g RO water, and 4.97 g 21.5% NaOH (prepared in ice bath) added to slurry over 1 minute, then 4.20 g SR268 added over 1 minute, then hold at 95° C. for 180 minutes, then added 1.90 g Potassium Persulfate over 1 minute, and then hold at 95° C. for 180 minutes. The temperature is then reduced to 25° C. in 90 minutes. The formed capsules have a median particle size of 28.44 micron. The prepared slurry shows no aggregation in heavy duty liquid laundry matrix.

### Example 19. Crosslinked Chitosan Delivery Particles Modified with 50% Molar Acrylic Acid and KPS

A chitosan stock solution is prepared by dispersing 155.7 g chitosan Chitoclear into 3304 g deionized water while mixing in a jacketed reactor. 1.56 g Potassium Persulfate added. The pH of the chitosan dispersion is then adjusted to 5.84 using 57.24 g concentrated HCl under agitation. The temperature of the chitosan solution is then increased to 65° C. over 30 minutes, then to 85° C. in 30 minutes, then to 95° C. in 30 minutes, and then held at 95° C. for 2 hours to hydrolyze the ChitoClear. The temperature is then reduced to 25° C. after the hydrolyzing step over a period of 90 minutes. The pH of the acid-treated chitosan solution is 5.83.

A water phase is prepared by mixing 433.6 g of the above chitosan stock solution and in a jacketed reactor at 25° C. An oil phase is prepared by mixing 129.0 g perfume and 32.0 g isopropyl myristate together along with 4.88 g Takenate D-110N at room temperature. The oil phase is added to the water phase under high shear milling to obtain an emulsion with desired particle size. The emulsion is heated to 60° ° C. in 45 minutes, then to 95° C. in 60 minutes. 30 minutes after getting to 95° C., a solution of 4.16 g Acrylic Acid, 4.16 g RO water, and 8.04 g 21.5% NaOH (prepared in ice bath) added to slurry over 1 minute, and then hold at 95° C. for 360 minutes. The temperature is then reduced to 25° C. in 90 minutes. The formed capsules have a median particle size of 27.86 micron. The prepared slurry shows no aggregation in heavy duty liquid laundry matrix.

### Example 20. Crosslinked Chitosan Delivery Particles In-Situ Modified with 50% Molar Neutralized CD9055, 5.5% Molar SR268, and 10% Mass KPS of Chitosan

A chitosan stock solution is prepared by dispersing 155.7 g chitosan Chitoclear into 3304 g deionized water while mixing in a jacketed reactor. 1.56 g Potassium Persulfate added. The pH of the chitosan dispersion is then adjusted to 5.84 using 57.37 g concentrated HCl under agitation. The temperature of the chitosan solution is then increased to 65° C. over 30 minutes, then to 85° C. in 30 minutes, then to 95° C. in 30 minutes, and then held at 95° C. for 2 hours to hydrolyze the ChitoClear. The temperature is then reduced to 25° C. after the hydrolyzing step over a period of 90 minutes. The pH of the acid-treated chitosan solution is 5.82.

A water phase is prepared by mixing 432.5 g of the above chitosan stock solution and in a jacketed reactor at 25° C. An oil phase is prepared by mixing 110.0 g perfume and 27.3 g isopropyl myristate together along with 4.15 g Takenate D-110N at room temperature. The oil phase is added to the water phase under high shear milling to obtain an emulsion with desired particle size. The emulsion is heated to 60° C. in 45 minutes, then to 95° C. in 60 minutes. Once at 95° C., a solution of 9.29 g CD9055, 9.29 g RO water, and 10.22 g 21.5% NaOH (prepared in ice bath) added to slurry over 1 minute, then 1.95 g SR268 added over 1 minute, then hold at 95° C. for 180 minutes, then added 1.96 g Potassium Persulfate over 1 minute, and then hold at 95° C. for 180 minutes. The temperature is then reduced to 25° C. in 90 minutes. The formed capsules have a median particle size of 30.26 micron.

### Example 21. Crosslinked Chitosan Delivery Particles Modified with CD9055, SR268, and KPS

A modified chitosan solution was prepared by dispersion 42.11 g chitosan powder in 840.00 g water at 70° C. The pH of the chitosan solution was then adjusted to 4.85 using 11.06 g glacial acetic acid. 35.82 g CD9055, an acidic acrylate oligomer was then added to the above chitosan mixture and mixed at 70° C. for 12 hours to obtain CD9055 modified chitosan solution. The pH of the obtained modified chitosan solution is 3.86.

266.7 g of the above modified chitosan solution is placed into a jacketed reactor at 25° C. and then the pH of the chitosan solution is adjusted to 9.27 using 18.84 g 21.5% caustic soda solution at room temperature. The potassium persulfate solution comprising 2.06 g potassium persulfate and 50 g water was then added to the chitosan solution to form a water phase.

An oil phase is prepared by mixing 99.71 g perfume, 2.72 g Takenate D110 and 24.93 g isopropyl myristate at 25° C. in a beaker.

The oil phase is added into the water phase under high shear for a period of time to obtain an emulsion at room temperature.

The emulsion is heated to 70° C. and then 13 g SR268 was then added to the emulsion. The emulsion is then heated to 90° C. in 60 minutes and held for 8 hours to cure the wall. The emulsion is then cooled down to 25° C. in 90 minutes. The obtained encapsulate, in the form of a water slurry, has median particle size of 43.94 micron. The QFO and 1 week leakage of the capsule slurry is 0.13% and 3.27% respectively. The prepared slurry shows no aggregation in heavy duty liquid laundry matrix.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A treatment composition comprising a treatment adjunct and a population of delivery particles,
wherein the delivery particles comprise a core and shell surrounding the core,
wherein the core comprises a benefit agent,
wherein the shell comprises a polymeric material that is the reaction product of a
modified chitosan and at least one electrophile,
wherein the modified chitosan comprises the reaction product of chitosan and a modifying compound,
wherein the modifying compound comprises an epoxide, an aldehyde, or an α,β-unsaturated compound.

2. The treatment composition according to claim 1, wherein the modifying compound comprises a cationic group, an anionic group, a nonionic group, or a mixture thereof.

3. The treatment composition according to claim 1, wherein the modifying compound comprises a cationic group, an anionic group, or a mixture thereof.

4. The treatment composition according to claim 1, wherein the modifying compound comprises an acidic group, a hydroxyl group, a quaternary ammonium group, or a mixture thereof.

5. The treatment composition according to claim 1, wherein the modifying compound comprises an α,β-unsaturated compound.

6. The treatment composition according to claim 1, wherein the modifying compound comprises an α,β-unsaturated compound,
wherein the α,β-unsaturated compound is selected from the group consisting of an acrylate, an alkyl acrylate, an α,β-unsaturated ester, an acrylic acid, an acrylamide, a vinyl ketone, a vinyl sulfone, a vinyl phosphonate, an acrylonitrile, or a combination thereof.

7. The treatment composition according to claim 1, wherein the modifying compound comprises a material selected from the group consisting of glycidyl trimethylammonium salt, glycidyl isopropyl ether, glycidyl methacrylate, furfuryl glycidyl ether, glycidol, 1,4-butanediol diglycidyl ether, 2-ethylhexyl glycidyl ether, (3-glycidyloxypropyl) trimethoxysilane, poly(ethylene glycol) diglycidyl ether, trimethylolpropane triglycidyl ether, glutaraldehyde, alginate aldehyde, acrylic acid, acrylate salt, maleic acid, vinyl sulfonic acid, 2-carboxyethyl acrylate, 2-(2-oxo-1-imidazolidinyl)ethyl methacrylate, 2-(2-oxo-1-imidazolidinyl)ethyl methacrylamide, (2-(acryloyloxy)ethyl)trimethylammonium salt, (3-(methacryloylamino)propyl) trimethylammonium salt, N,N-dialkylaminoalkyl acrylate, N,N-dialkylaminoalkyl acrylamide, (3-Acrylamidopropyl)trimethylammonium salt, 3-sulfopropyl acrylate salt, 2-acrylamido-2-methyl-1-propanesulfonic acid and their salts, quaternized vinyl imidazole, diallyl dialkyl ammonium salts, vinyl amine, and combinations thereof.

8. The treatment composition according to claim 1,
wherein the chitosan comprises free amine moieties, and
wherein the molar ratio of the modifying compound to the free amine moieties of the chitosan is from 0.1% to 100%.

9. The treatment composition according to claim 1, wherein the shell comprises at least 18%, by weight of the shell, of the modified chitosan.

10. The treatment composition according to claim 1, wherein the modified chitosan is characterized by a weight average molecular weight of from about 100 kDa to about 600 kDa.

11. A treatment composition comprising a treatment adjunct and a population of delivery particles,
wherein the delivery particles comprise a core and shell surrounding the core,
wherein the core comprises a benefit agent,
wherein the shell comprises a polymeric material that is a reaction product of at least one modified chitosan and at least one electrophile,
wherein the population of delivery particles is obtainable a process comprising the following steps:
forming a water phase by dissolving or dispersing chitosan in an aqueous acidic medium at a pH of 6.5 or less and a temperature of at least 25° C.,
the chitosan having free amine moieties;
forming an oil phase comprising combining together at least one benefit agent and at least one electrophile, preferably at least one polyisocyanate, optionally with an added oil;
forming an emulsion by mixing under high shear agitation the oil phase into an excess of the water phase, thereby forming droplets of the oil phase dispersed in the water phase;
adding to the water phase and/or to the emulsion, preferably at least to the water phase, a modifying compound,
the modifying compound comprising one or more of an epoxide, an aldehyde, or an α,β-unsaturated compound,
the modifying compound reacting with the free amine moieties of the chitosan;
optionally adjusting the pH of the emulsion to a pH of 4 or greater;
heating the emulsion to at least 40° C., for a time sufficient to form a shell at an interface of the droplets with the water phase, the shell surrounding the core.

12. A treatment composition comprising a treatment adjunct and a population of delivery particles,
wherein the delivery particles comprise a core and shell surrounding the core,
wherein the core comprises a benefit agent,
wherein the shell comprises a polymeric material that is a reaction product of at least one modified chitosan and at least one electrophile,
the modified chitosan comprising a reaction product of chitosan and a modifying compound,
wherein the modifying compound comprises an epoxide, an aldehyde, or an α,β-unsaturated compound that covalently bonds with the chitosan,
wherein the population of delivery particles is obtainable a process comprising the following steps:
dissolving or dispersing chitosan into a water phase, the chitosan having amine moieties;
combining the water phase and the modifying compound;
optionally adjusting the pH of the water phase to pH 3.0 or higher, preferably from pH 3.0 to pH 6;
optionally adjusting the temperature of the water phase to 25° C. or greater;
mixing the water phase for a period of time, thereby forming a modified chitosan,
wherein the modifying compound is covalently bonded through CN bonds with the amine moieties of the chitosan,
wherein the modified chitosan remains dissolved in the water phase;
providing an oil phase comprising dissolving together at least one benefit agent comprising an oil, and at least one electrophile, preferably at least one polyisocyanate, optionally with a second oil;
forming an emulsion by mixing under high shear agitation the oil phase into the water phase, thereby forming droplets of the oil phase and benefit agent dispersed in the water phase;
heating the emulsion to at least 40° C., for a time sufficient to form the shell at an interface of the droplets with the water phase, the shell surrounding the core.

13. The treatment composition according to claim 12, wherein the process by which the population of delivery particles is obtainable further comprises the step of adding a redox initiator to the water phase or the emulsion,
wherein the redox initiator comprises a persulfate, a peroxide, or a combination thereof.

14. The treatment composition according to claim 12, wherein the modifying compound comprises a cationic group and/or an anionic group.

15. The treatment composition according to claim 12, wherein the delivery particles comprise from about 1% to about 25%, by weight of the delivery particles, of the shell.

16. The treatment composition according to claim 12, wherein the shell degrades at least 50%, after 60 days when tested according to test method OECD 301B.

17. The treatment composition according to claim 12, wherein the delivery particles are characterized by a zeta potential of 150 mV or less at pH 4.5.

18. The treatment composition according to claim 12, wherein the electrophile comprises a polyisocyanate.

19. The treatment composition according to claim 12, wherein the benefit agent is a fragrance material.

20. The treatment composition according to claim 12, wherein the core further comprises a partitioning modifier.
